(19) United States
(12) Patent Application Publication
(10) Pub. No.: US 2010/0110850 A1
(43) Pub. Date: May 6, 2010

(54) INFORMATION RECORDING MEDIUM, INFORMATION RECORDING METHOD AND INFORMATION RECORDING APPARATUS

(75) Inventors: Yoshihisa TAKAHASHI, Osaka (JP); Hiroshi UEDA, Nara (JP); Motoshi ITO, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: Panasonic Corporation, Osaka (JP)

(21) Appl. No.: 12/264,300

(22) Filed: Nov. 4, 2008

(51) Int. Cl. G11B 7/00

(52) U.S. Cl. 369/47.53; 369/275.3; G9B/7

(57) ABSTRACT

OPC areas are used for adjusting recording parameters (power and strategy). In an optical disc including two recording layers, the recording power for one recording layer is likely to be influenced by a transmittance variance or the like provided by the recording state of the other recording layer (either already recorded or unrecorded). In addition, recording is performed while changing the power. For these reasons, the OPC areas are located so as not to be at the same radial positions among the recording layers. However, as the number of recording layers is increased, the area size for securing the OPC areas is increased, which may undesirably lead to an increase of the lead-in zone or the lead-out zone (decrease of the user data zone) and a decrease of the OPC area size in each recording layer (decrease of the number of times of usage by the user). According to the present invention, an area for power calibration in which recording is performed while changing the power and so which is significantly influenced by the transmittance balance, is separated from an area for strategy calibration or the like in which recording is performed at a fixed power suitable to the disc and so which is unlikely to be influenced by the transmittance balance. Only power calibration areas are located at different radial positions among different recording layers so as not be influenced by the recording state of the other recording layers, and the strategy calibration areas are located so as to include the same radial position among different recording layers.

### BACKGROUND OF THE INVENTION

1. Field of the Invention

The present invention relates to an information recording medium including a plurality of recording layers having an area for recording calibration, and a recording method and a recording apparatus for such a recording medium; and is especially effective for, for example, a write once optical disc such as a BD-R or the like.

2. Description of the Related Art

Recently, large-capacity and exchangeable information recording mediums and disc drives used for the same are in wide use.

As conventional large-capacity and exchangeable information recording mediums, optical discs including DVDs and Blu-ray discs (hereinafter, also referred to as “BDs”) are well known. An optical disc drive apparatus performs recording or reproduction by forming tiny pits (recording marks) on an optical disc using laser light, and is suitable for large-capacity and exchangeable information recording. DVDs are characterized by using red laser light, and BDs are characterized by using blue laser light having a wavelength shorter than that of red laser light. Owing to this, BDs have a higher recording density to realize a larger capacity than DVDs.

Moreover, in recent years, multi-layer optical discs, namely, optical discs including a plurality of recording layers have been actively developed for further increasing the capacity. As DVDs and BDs, two-layer discs including two recording layers are already on the market. In the future, discs including a larger number of layers, such as a six-layer or eight-layer discs, are expected to be available.

FIG. 1 is a conceptual view of a three-layer optical disc including three recording layers. An optical disc 1 includes a substrate 2, and recording layers 3, 5 and 7 stacked on the substrate 2. Between the recording layers, intermediate layers 4 and 6 having a role of protecting the recording layers are provided, and a surface of the disc is covered with a cover layer 8 formed of a polycarbonate resin or the like. Optical laser light is directed from the side of the cover layer 8, which is the disc surface. The recording layer formed in contact with the substrate 2, i.e., the recording layer farthest from the disc surface is used as the reference layer. The recording layers are numbered orderly from the reference layer; i.e., the recording layer 3 is called L0 layer, the recording layer 5 is called L1 layer, and the recording layer 7 is called L2 layer. Hereinafter, in this specification, this manner of labeling will be adopted. This manner of labeling is merely an example, and there are occasions where the recording layers are called L0 layer, L1 layer, etc. from the recording layer closest to the disc surface.

FIG. 2 shows an area arrangement of a recording layer of a general optical disc. On a recording layer of a discus-shaped optical disc 1, a great number of tracks 11 are formed spirally. In each track 2, a great number of tiny blocks 12 are formed.

The width of the track 11 (track pitch) is, for example, 0.32 μm in the case of a BD. The block 12 is an error correction unit, and is a minimum unit by which a recording or reproduction operation is performed. The block 12 has a size of, for example, 1ECC (size: 32 kbytes) in the case of a DVD and 1 cluster (size: 64 kbytes) in the case of a BD. In terms of “sector” (size: 2 kbytes), which is the minimum unit of data of an optical disc, ECC and cluster are represented as 1ECC=16 sectors and 1 cluster=32 sectors.

Each recording layer includes a lead-in zone 13, a data zone 14 and a lead-out zone 15.

The data zone 14 is a zone where the user can record any information, for example, real-time data of music or video, computer data such as sentences, data bases or the like.

The lead-in zone 13 is positioned inner to the data zone 14 along a radial direction of the optical disc 1. The lead-out zone 15 is positioned outer to the data zone 14 along the radial direction of the optical disc 1. These zones include an area usable for recording management information on the optical disc 1 (DMA area, temporary DMA area, etc.), an area usable for adjusting a recording power, etc. (OPC area) and the like. These zones also have a role of preventing overrun of an optical pickup (not shown).

On such an optical disc, it is important to record information with an optimal recording condition (for example, recording power and strategy (e.g. pulse generation timing and pulse length)) from the viewpoint of the recording and reproduction quality. For realizing this, trial recording (hereinafter, recording calibration) is widely performed in a prescribed area of the optical disc to find the optimal power and strategy (for example, Japanese Laid-Open Patent Publication No. 2007-305188).

Recording calibration is performed in a recording calibration area (hereinafter, referred to as an “OPC area”) included in the lead-in zone 13, the lead-out zone 15 or the like.

FIG. 18 shows a flow of a general recording calibration procedure.

Step 1801: The recording power is adjusted (hereinafter, referred to “power calibration”). Specifically, recording is performed while changing the recording power (step-by-step recording), the recording quality of the recorded area (for example, modulation degree or BER (Block Error Rate), etc.) is measured, and an optimal power at which the recording quality is optimal is found.

Step 1802: The recording strategy is adjusted while the recording power is fixed (hereinafter, referred to as “strategy calibration”). Specifically, recording is performed while changing the pulse width with the recording power being fixed at the optimal power found in step 1801, the recording quality of the recorded area is measured, and an optimal strategy at which the recording quality is optimal is found.

On an optical disc such as a BED, data is recorded by irradiating the recording layer with laser light to change the recording layer, for example, from an amorphous state to a crystalline state. Since the state of the recording layer is changed in this manner, the transmittance and reflectance of the light (i.e., optical characteristics) are changed. Namely, a recorded area and a non-recorded area have different optical characteristics. Therefore, when an optimal recording power is found by power calibration for an optical disc including two or more recording layers, the power found for one recording layer varies depending on the recording state of the other recording layer (either already recorded or unrecorded). Specifically, the following may occur, for example: recording is performed with an excessively large power while adjusting the recording power, and as a result, the area used for the calibration is destroyed, which influences the recording characteristic of the other recording layer corresponding to the destroyed area. Even if an excessively large power sufficient to destroy an area is not used, the transmittance varies by the magnitude of the power used for the recording. Especially, an area in which recording has been performed with a power not suitable to the optical disc is more likely to be influenced by the transmittance balance than an area in which recording has been performed with a suitable power. As can been seen from this, the transmittance of the laser light is varied by the recording state of the other layer. Therefore, the recording characteristics become different. Especially in the case where power calibration is performed by which recording is performed while changing the power, the transmittance varies within the recorded area. In addition, for power calibration, recording may be performed at a recording power exceeding the range suitable to the optical disc in order to find an optimal recording power. An area in which power calibration has been performed is one of areas which influence the transmittance most. Therefore, when an area used for power calibration in another layer is irradiated with laser light to perform recording, such an area is significantly influenced by the transmittance balance of the another layer. From the recording quality of an area in which recording has been performed with a transmittance in such a varied state, the appropriate power cannot be correctly. As a method for avoiding these problems, a method of restricting the locations of OPC areas is well known (for example, Japanese Laid-Open Patent Publication No. 2005-038584 and PCT National Phase Japanese Laid-Open Patent Publication 2007-521606).

FIG. 19 shows locations of the OPC areas in an optical disc including two recording layers. A first recording calibration area 200 provided in the recording layer L0 and a second recording calibration area 201 provided in the recording layer L1 are located at different radial positions. In addition, in an area of the other layer existing between the recording calibration area and the disc surface, namely, a position of the recording layer L1 in a range corresponding to the first recording calibration area 200, a reserved area 210 (unused area) is provided. In the case of a write once medium on which recording can be performed only once, an unused reserved area is in an unrecorded state. Therefore, regardless of the recording layer in which the recording calibration area is used, such an area is a reserved area until the laser light reaches the recording calibration area (i.e., such an area remains unrecorded in the case of the write once medium). Thus, the recording calibration area is not influenced by the transmittance of the other recording layer, and recording calibration can be always performed under the same conditions.

In consideration of a recording medium including more than two recording layers, Patent Document 3, for example, provides a case where an OPC area in an odd-numbered recording layer and an OPC area in an even-numbered recording layer adjacent to the odd-numbered recording layer are located at different radial positions. Namely, the OPC areas in odd-numbered recording layers or the OPC areas in the even-numbered recording layers may be located at the same radial position; or the OPC areas may be located at different radial positions in all the recording layers.

With this method, however, the following problem occurs when the number of recording layers increases. The most serious problem is that as the number of recording layers increases, it becomes difficult to securely obtain OPC areas and reserved areas.

FIG. 20 shows locations of OPC areas in an optical disc including three recording layers arranged by the conventional method. For the convenience of description, the OPC areas in all the recording layers have the same size (for example, S cluster). As shown in FIG. 20(A), when the OPC areas are located at different radial positions among all the three layers, the size of 3×S cluster is necessary for each layer. The 2×S cluster areas corresponding to the reserved areas are not usable. Considering that the size of each of the lead-in zone 13 and the lead-out zone 15 is limited, it is not preferable that as the number of layers increases, the size of the reserved areas, i.e., the unusable areas increases.

As shown in FIG. 20(B), when the OPC areas in the odd-numbered recording layers or in the even-numbered recording layers are located at the same radial position, the required size is 2×S as in the case of an optical disc including two recording layers. However, in this case, the problem that the power found is varied by the recording state of another recording layer cannot be solved.

There is another method, by which the size of the lead-in zone 13 or the lead-out zone 15 is increased in order to obtain the OPC areas. As the size of these zones increases, the size of the data zone 14 is decreased accordingly. When the size of the data zone 14 is decreased in order to obtain the size of the OPC areas, the capacity usable for recording user data is decreased, which is disadvantageous to the user. Therefore, it is preferable that the lead-in area 13 and the lead-out area 15 are as small as possible.

In order to obtain the OPC areas at different radial positions in all the layers as in FIG. 20(A), it is conceivable to decrease the size of the OPC areas to decrease the ratio of the OPC area (and the reserved area) with respect to the lead-in zone 13 or the lead-out zone 15. However, as the size of the OPC areas is decreased, the number of times the recording calibration can be performed is decreased accordingly. In general, on mediums (recording layers) for which recording calibration cannot be performed, recording is often prohibited because the recording power or the like cannot be guaranteed for such mediums. Therefore, decrease of the size of the OPC areas provides disadvantages to the user at a high possibility and is not preferable.

### SUMMARY OF THE INVENTION

An information recording medium according to the present invention comprises a plurality of recording layers; wherein: each recording layer includes a recording calibration area usable for performing calibration accompanying recording; and the recording calibration area includes a precise calibration area usable for performing precise calibration, which is final recording calibration for finding an optimal condition for recording; and a rough calibration area usable for performing rough calibration, which is rough recording calibration carried out before the precise calibration. Thus, the above-described object is achieved.

An information recording medium according to the present invention comprises a plurality of recording layers; wherein: each recording layer includes a recording calibration area usable for performing recording calibration; the recording calibration areas of two adjacent recording layers among the plurality of recording layers are located so as to have areas overlapping in a radial direction; the recording calibration includes first calibration, accompanied by recording at an arbitrary recording power, performed for finding a recording power generally suitable to the information recording medium; and second calibration accompanied by recording at the recording power found by the first calibration; and regarding the recording calibration areas, the recording calibration areas, of the two adjacent recording layers, used for the first calibration do not include areas overlapping in the radial direction; and the recording calibration areas, of the two adjacent recording layers, used for the second calibration include areas overlapping in the radial direction. Thus, the above-described object is achieved.

The recording power generally suitable may be a recording power which provides a post-recording transmittance in a prescribed range.

An information recording medium according to the present invention comprises a plurality of recording layers; wherein: each recording layer includes a first calibration area usable for performing recording at an arbitrary recording power; and a second calibration area usable for performing recording at a recording power generally suitable to the information recording medium; the first calibration areas of two adjacent recording layers among the plurality of recording layers are located so as not to include areas overlapping in a radial direction; and the second calibration areas of two adjacent recording layers among the plurality of recording layers are located so as to include areas overlapping in the radial direction. Thus, the above-described object is achieved.

The recording power generally suitable may be a recording power which provides a post-recording transmittance in a prescribed range.

An information recording apparatus according to the present invention is for an information recording medium including a plurality of recording layers; wherein: each recording layer includes a recording calibration area usable for performing calibration accompanying recording; the recording calibration area includes a precise calibration area usable for performing precise calibration, which is final recording calibration for finding an optimal condition for recording; and a rough calibration area usable for performing rough calibration, which is rough recording calibration carried out before the precise calibration; and the information recording apparatus comprises (a) a rough calibration control section for performing the rough calibration in the rough calibration area; and (b) a precise calibration control section for performing the precise calibration in the precise calibration area. Thus, the above-described object is achieved.

An information recording apparatus according to the present invention is for an information recording medium including a plurality of recording layers; wherein: each recording layer includes a recording calibration area usable for performing recording calibration; the recording calibration areas of two adjacent recording layers among the plurality of recording layers are located so as to have areas overlapping in a radial direction; the recording calibration includes first calibration, accompanied by recording at an arbitrary recording power, performed for finding a recording power generally suitable to the information recording medium; and second calibration accompanied by recording at the recording power found by the first calibration; and the information recording apparatus comprises (a) a first calibration section for performing the first calibration in one of two adjacent recording layers among the plurality of recording layers, such that the recording calibration area for the first calibration does not overlap, in the radial direction, the recording calibration area of the other of the two recording layers already used for the first calibration; and (b) a second calibration section for performing the second calibration. Thus, the above-described object is achieved.

The recording power generally suitable may be a recording power which provides a post-recording transmittance in a prescribed range.

An information recording apparatus according to the present invention is for an information recording medium including a plurality of recording layers; wherein: each recording layer includes a first calibration area usable for performing recording at an arbitrary recording power; and a second calibration area usable for performing recording at a recording power generally suitable to the information recording medium; the first calibration areas of two adjacent recording layers among the plurality of recording layers are located so as not to include areas overlapping in a radial direction; the second calibration areas of two adjacent recording layers among the plurality of recording layers are located so as to include areas overlapping in the radial direction; and the information recording apparatus comprises (a) a first calibration control section for performing recording calibration in the first calibration area; and (b) a second calibration control section for performing recording calibration in the second calibration area. Thus, the above-described object is achieved.

The recording power generally suitable may be a recording power which provides a post-recording transmittance in a prescribed range.

An information recording method according to the present invention is for an information recording medium including a plurality of recording layers; wherein: each recording layer includes a recording calibration area usable for performing calibration accompanying recording; the recording calibration area includes a precise calibration area usable for performing precise calibration, which is final recording calibration for finding an optimal condition for recording; and a rough calibration area usable for performing rough calibration, which is rough recording calibration carried out before the precise calibration; and the information recording method comprises the steps of (a) performing the rough calibration in the rough calibration area; and (b) performing the precise calibration in the precise calibration area. Thus, the above-described object is achieved.

An information recording method according to the present invention is for an information recording medium including a plurality of recording layers; wherein: each recording layer includes a recording calibration area usable for performing recording calibration; the recording calibration areas of two adjacent recording layers among the plurality of recording layers are located so as to have areas overlapping in a radial direction; the recording calibration includes first calibration, accompanied by recording at an arbitrary recording power, performed for finding a recording power generally suitable to the information recording medium; and second calibration accompanied by recording at the recording power found by the first calibration; and the information recording method comprises the steps of (a) performing the first calibration in one of two adjacent recording layers among the plurality of recording layers, such that the recording calibration area for the first calibration does not overlap, in the radial direction, the recording calibration area of the other of the two recording layers already used for the first calibration; and (b) performing the second calibration in the recording calibration area. Thus, the above-described object is achieved.

The recording power generally suitable may be a recording power which provides a post-recording transmittance in a prescribed range.

An information recording method according to the present invention is for an information recording medium including a plurality of recording layers; wherein: each recording layer includes a first calibration area usable for performing recording at an arbitrary recording power; and a second calibration area usable for performing recording at a recording power generally suitable to the information recording medium; the first recording areas of two adjacent recording layers among the plurality of recording layers are located so as not to include areas overlapping in a radial direction; the second recording areas of two adjacent recording layers among the plurality of recording layers are located so as to include areas overlapping in the radial direction; and the information recording method comprises the steps of (a) performing recording calibration in the first calibration area; and (b) performing recording calibration in the second calibration area. Thus, the above-described object is achieved.

The recording power generally suitable may be a recording power which provides a post-recording transmittance in a prescribed range.

In a recording medium including a plurality of recording layers, an area usable for performing calibration, such as recording power calibration, by which recording is performed while changing the recording power, i.e., at a recording power not guaranteed as an optimal power and so which significantly influences the transmittance, is separated from an area usable for performing calibration, such as strategy calibration, by which recording is performed by fixing the recording power at an optimal power and so which does not influence the transmittance. Among all the recording layers, the areas usable for performing calibration, by which recording is performed while changing the recording power, i.e., at a recording power not guaranteed as an optimal power, are located at different radial positions. Thus, the size required by the OPC areas (and the reserved areas) for recording calibration is kept minimum, and also the influence exerted on the calibration result of the other recording layers can be minimized.

### BRIEF DESCRIPTION OF THE DRAWINGS

FIG. 1 is a structural view of a general optical disc including three recording layers.

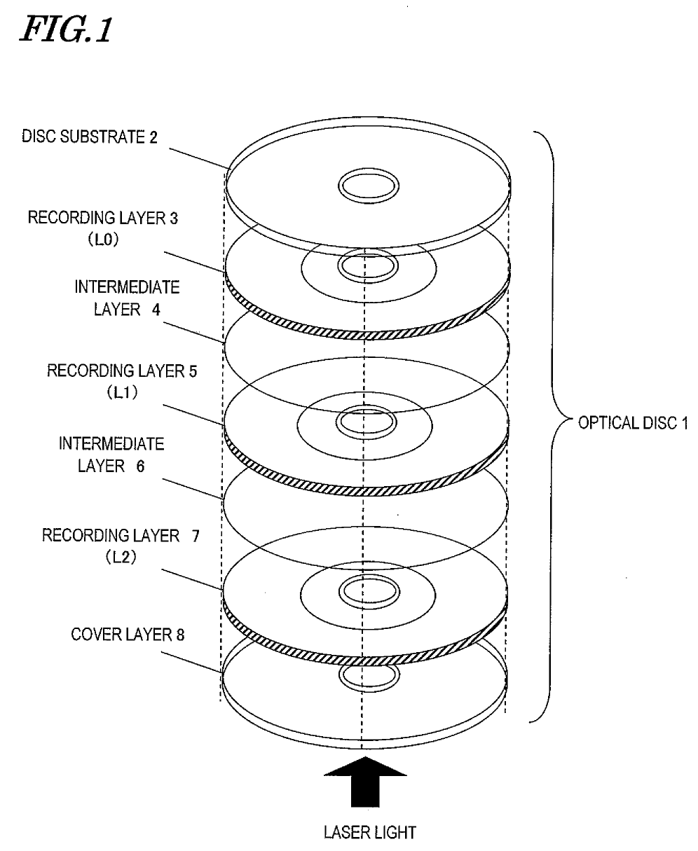

FIG. 2 shows a recording layer of a general optical disc.

FIG. 3 shows an area arrangement of an optical disc according to Embodiment 1 of the present invention.

FIG. 4 shows a range influenced by laser light radiation according to Embodiments 1 and 2 of the present invention.

FIG. 5 shows how to use the areas of the optical disc according to Embodiment 1 of the present invention.

FIG. 6 shows the order in which the power calibration areas of the optical disc are used according to Embodiment 1 of the present invention.

FIG. 7 shows a data structure relating to recording calibration in the optical disc according to Embodiment 1 of the present invention.

FIG. 8 shows information relating to power calibration in the optical disc according to Embodiment 1 of the present invention.

FIG. 9 is a structural view of an optical disc recording and reproduction apparatus according to Embodiments 1 and 2 of the present invention.

FIG. 10 shows a recording calibration procedure according to Embodiments 1 and 2 of the present invention.

FIG. 11 shows another example of an area arrangement of an optical disc according to Embodiment 1 of the present invention.

FIG. 12 shows an area arrangement of an optical disc according to Embodiment 2 of the present invention.

FIG. 13 shows how to use the areas of the optical disc according to Embodiment 2 of the present invention.

FIG. 14 shows a data structure relating to recording calibration in the optical disc according to Embodiment 2 of the present invention.

FIG. 15 shows an area arrangement of an optical disc according to Embodiment 3 of the present invention.

FIG. 16 shows how to use the areas of the optical disc according to Embodiment 3 of the present invention.

FIG. 17 shows a data structure relating to recording calibration in the optical disc according to Embodiment 3 of the present invention.

FIG. 18 shows a flow illustrating a concept of a general recording calibration procedure.

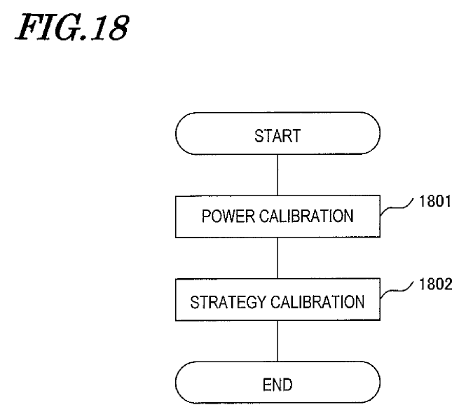

FIG. 19 shows an area arrangement of an optical disc in an example of the conventional art.

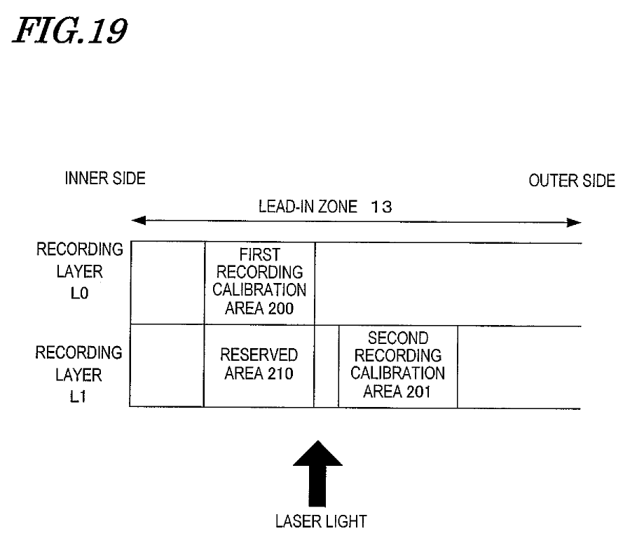

FIG. 20 shows an area arrangement of an optical disc including three recording layers to which the conventional art is applied.

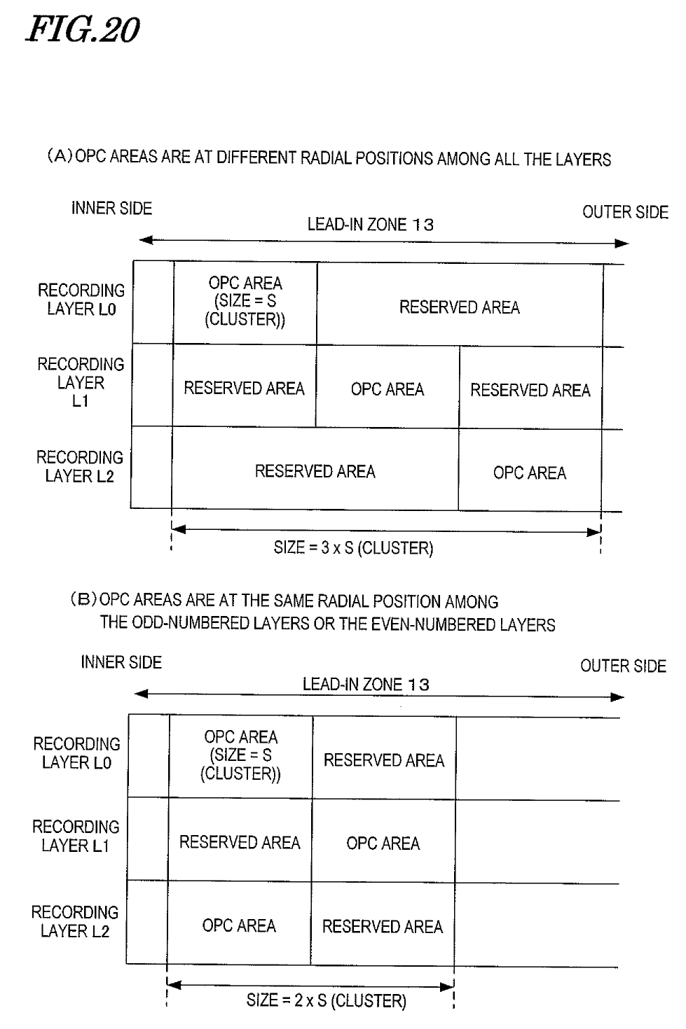

### DETAILED DESCRIPTION OF PREFERRED EMBODIMENTS

Hereinafter, embodiments of the present invention will be described with reference to the drawings. In the embodiments of the present invention, a write once information recording medium on which recording can be performed only once is used as an information recording medium.

### Embodiment 1

(1) Area Arrangement

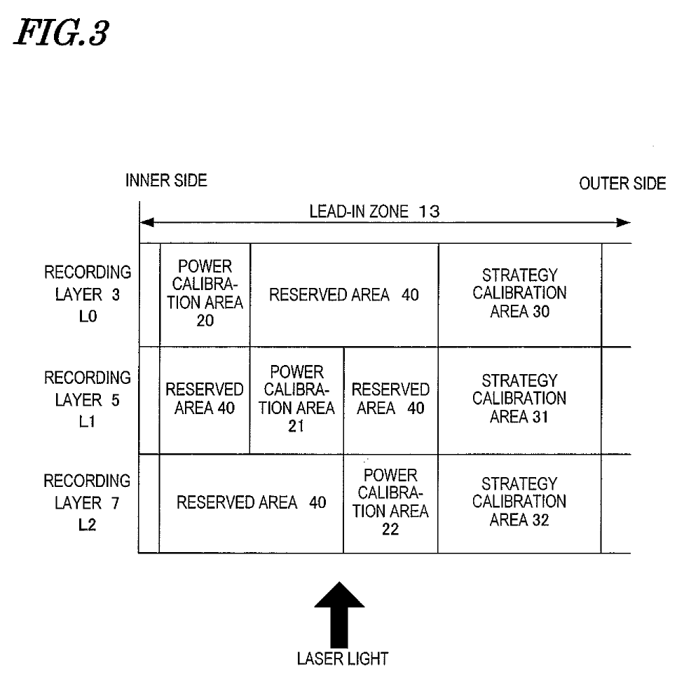

FIG. 3 shows an area arrangement of a write once optical disc including three recording layers according to Example 1 of the present invention.

The optical disc 1 includes L0 layer (recording layer 3), L1 layer (recording layer 5) and L2 layer (recording layer 7) sequentially from the one farthest from the side to which the laser light is directed (i.e., sequentially from the substrate 2).

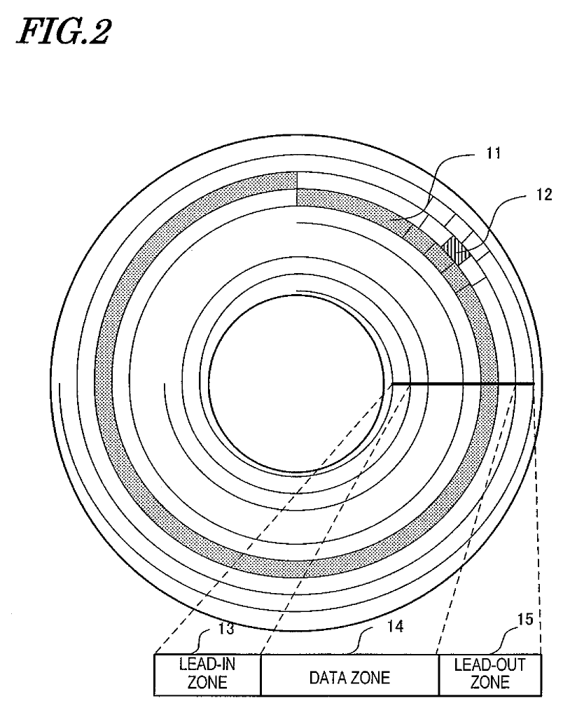

As shown in FIG. 2, each recording layer includes a lead-in zone 13, a data zone 14 and a lead-out zone 15. The lead-in zone 13 of each recording layer includes a power calibration area as an OPC area for recording calibration (L0 layer includes a power calibration area 20, L1 layer includes a power calibration area 21, and L2 layer includes a power calibration area 22), and a strategy calibration area (L0 layer includes a strategy calibration area 30, L1 layer includes a strategy calibration area 31, and L2 layer includes a strategy calibration area 32). The recording layers each include a reserved area(s) 40 at the same radial position(s) as the power calibration area(s) in the other recording layers.

In Example 1 of the present invention, the lead-in zone 13 includes the OPC areas for recording calibration, but the present invention is not limited to this. Namely, the OPC areas for recording calibration may be further included in the lead-out zone 15. Alternatively, for example, an OPC area may be included in either the lead-in area 13 or the lead-out area 15 in each recording layer.

The reserved area 40 is located at the same radial position as the power calibration area of another recording layer. Until the power calibration area in the another recording layer located at the same radial position as the reserved area 40 is used, the reserved area 40 in at least a recording layer which is present between the another recording layer having such a power calibration area to be used and a disc surface (laser light incident surface) remains unused (in the case of a write once optical disc, unrecorded).

The power calibration area is an area usable for performing calibration of a recording power (power calibration). The power calibration area is mainly used for finding an optimal recording power by performing recording therein while, for example, changing the recording power. As shown in FIG. 3, the power calibration area 20, the power calibration area 21 or the power calibration area 22 present in each recording layer is located so as not to include an area overlapping the power calibration area of another recording layer in the radial direction, i.e., is located at a different radial position from the power calibration area of another recording layer. The reason is, as described above, a difference in an optical characteristic such transmittance, reflectance or the like caused by the recording state of another recording layer (especially, the transmittance or reflectance in the case where an area of another recording layer located at an overlapping radial position was used for power calibration of performing recording while changing the recording power) significantly influences the recording power. The above setting is especially made such that an area of another recording layer which passes the laser light for recording calibration is not an area which was used for power calibration of performing recording while changing the recording power. For example, the optical characteristic can be prevented from being varied by keeping constant the recording state of another recording layer (reserved area 40 which is unused).

The strategy calibration area is an area usable for performing recording pulse width calibration (strategy calibration). The strategy calibration area is mainly used for finding an optimal strategy by performing recording therein while, for example, fixing the recording power at the recording power suitable to the optical disc 1 which was found by the power calibration and changing the pulse width. As shown in FIG. 3, the strategy calibration area 30, the strategy calibration area 31 or the strategy calibration area 32 present in each recording layer is secured as a different area from the power calibration area, and is located so as to include an area overlapping the strategy calibration area of another recording layer in the radial direction, i.e., is located at the same radial position as the strategy calibration area of another recording layer as shown in FIG. 3. This is done utilizing the characteristic that the transmittance balance of an area having data recorded at a recording power generally suitable to the optical disc 1 is not largely destroyed, and the transmittance can be suppressed within a prescribed range. In strategy calibration, recording is performed at a recording power suitable to the optical disc 1. Therefore, even if recording is performed with laser light which was passed through an area of another recording layer in which strategy calibration area was already performed, the transmittance of the current strategy calibration area is not substantially influenced by the recording state of the another recording layer (can be suppressed to a negligible level).

In FIG. 3, the borders of the power calibration areas of the recording layers are shown as being exactly the same radial position. In actuality, however, the borders cannot be exactly the same radial position because of aligning errors of the recording layers made during the optical disc production, or influences of characteristics of laser light.

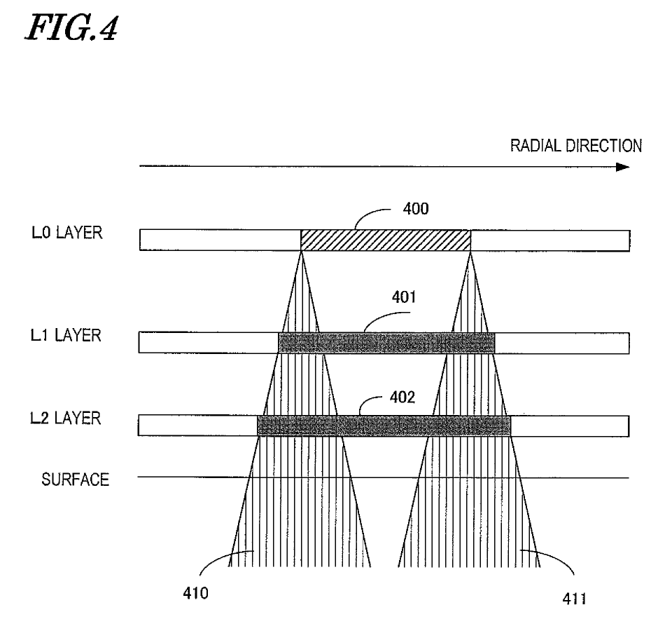

FIG. 4 shows the influence of laser light on each recording layer. For example, it is assumed that recording is performed in an area 400 of L0 layer continuously. As shown in the figure, laser light is collected on L0 layer and moves between a range 410 and a range 411. The recording in the area 400 of L0 layer is influenced by the optical characteristic provided by the recording state of an area 401 of L1 layer and also by the optical characteristic provided by the recording state of an area 402 of L2 layer. When recording is performed in a layer far from the layer light, a recording layer closer to the laser light receives the laser light in an expanded state. It should be considered that even if the recording is performed at the same radial position, the size of the area in which the optical characteristic needs to be kept constant, namely, the size of the area which is to be kept unused, is made larger by the amount approximately corresponding to this expansion in the recording layer closer to the laser light. Therefore, needless to say, the actual arrangement of the power calibration areas need to be made in consideration of such an influence as well as the radial positions.

It should be noted that although the positions are not exactly the same in radial direction, but such influences will not be described unless otherwise specified in this specification, for the convenience of explanation. Namely, although not explicitly described, the aligning errors and the influence of the expansion of the laser light are inevitable issues and should be considered, needless to say. In this specification, the radial positions which are the same with such aligning errors and the influence of the laser light being considered may be explicitly referred to the “same radial range positions” occasionally, but such “same radial positions” still include these influences.

As described above in Embodiment 1 of the present invention, recording power calibration is performed with a recording power which cannot be guaranteed as the optimal power, i.e., while changing the recording power. Therefore, a power calibration area of one recording layer used for recording power calibration is significantly influenced by the transmittance balance provided by the recording state of another recording layer. Such a power calibration area is located at a different radial position from the power calibration area of another recording layer. By contrast, strategy calibration is performed while fixing the recording power to the optimal recording power. Therefore, a strategy calibration area of one recording layer used for strategy calibration is unlikely to be influenced by the transmittance provided by the recording state of another recording layer. Such a strategy calibration area is located at the same radial position among all the recording layers. Owing to such an arrangement, the recording calibration results of all the recording layers are protected against being influenced by the recording state of a different recording layer. In addition, the size of areas secured as OPC areas, which are required when the number of recording layers is increased (i.e., the total size of the power calibration areas, the strategy calibration areas and the reserved areas) can be suppressed to be minimum. Therefore, an area necessary for recording calibration can be secured, and the problem that the number of times of usage by the user (=the number of times the recording calibration can be made) is decreased is solved. In addition, an increase of the size of the lead-in zone 13 or the lead-out zone 15 can be suppressed, and the problem that the size of the data zone 14 is decreased and the size of the area usable by the user is decreased can be solved.

The arrangement of the areas does not need to be the same as that in FIG. 3. For example, in FIG. 3, the power calibration areas are located from the innermost end in L0 toward the outermost end in L2, but this is merely an example. Any arrangement is usable as long as the power calibration areas are located at different radial positions among the different recording layers, and an area of each recording layer located at the same radial position as the power calibration area of another recording layer is in an unused state until the power calibration area of the another recording layer is used.

The reserved area 40 is basically kept unused, but may be used depending on the conditions. Specifically, this area only needs to be unused until the power calibration area of another recording layer is used (in the case of a write once optical disc, unrecorded). Namely, after the power calibration area of the another recording layer located at the same radial position is used, this area is usable with no influence. Accordingly, for example, when a strategy calibration area is short of, or out of, capacity, the reserved area can be re-assigned and used as a strategy calibration area. This is applicable to other areas as well as the reserved area 40. For example, when a power calibration areas is used up but the strategy calibration area still has some room left, a part of such a strategy calibration area may be re-assigned and used as a power calibration area, as long as the recording state of the other recording layers at the same radial position is in the same state (unused); or vice versa. The reserved areas may be used for other purposes than recording calibration, for example, for recording of updates of the management information or for storing inherent information of the recording apparatus which performed the recording.

(2) How to Use the Areas

In general, an access to the optical disc 1 is made using an address physically assigned on the recording layer (physical address; hereinafter, referred to simply as “PBA”). A physical address is roughly classified as one physically embedded in the form of a wobble or the like on the track 11 of the disc, i.e., on a wall surface of the recording groove; or as one provided in the data recorded on the disc. In this specification, the “physical address” indicates the former, namely, the one physically embedded using the wobble or the like of the recording groove, unless otherwise specified.

Physical addresses (PBAs) are sequentially assigned in an ascending order in the direction of the track path of the disc. More specifically, in the case of a two-layer recording disc including two recording layers (L0 layer and L1 layer), an addressing method called “opposite path” is generally used. Namely, physical addresses are assigned in an ascending order from the innermost end toward the outermost end in L0 layer, whereas physical addresses are assigned in an ascending order from the outermost end toward the innermost end in L1 layer.

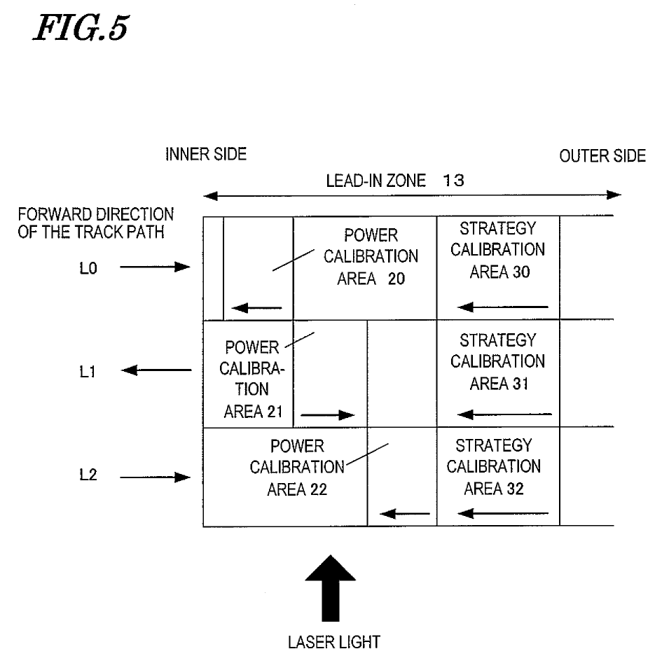

FIG. 5 shows an example of how to use the power calibration areas and the strategy calibration areas in a write once optical disc according to Embodiment 1 of the present invention. In the example of FIG. 5, the same area arrangement as shown in FIG. 3 is used.

In FIG. 5, arrows represent the directions in which the power calibration areas and the strategy calibration areas are used (recording directions).

As shown in FIG. 5, the power calibration areas are used in the opposite direction to the track path. The reason is as follows. At the stage of power calibration, the power calibration has not been made, naturally. It cannot be guaranteed at which power the recording will be performed. Therefore, the track 11 may be possibly destroyed by performing recording at an excessively high power. In consideration of this, the power calibration areas are used in the opposite direction to the track path.

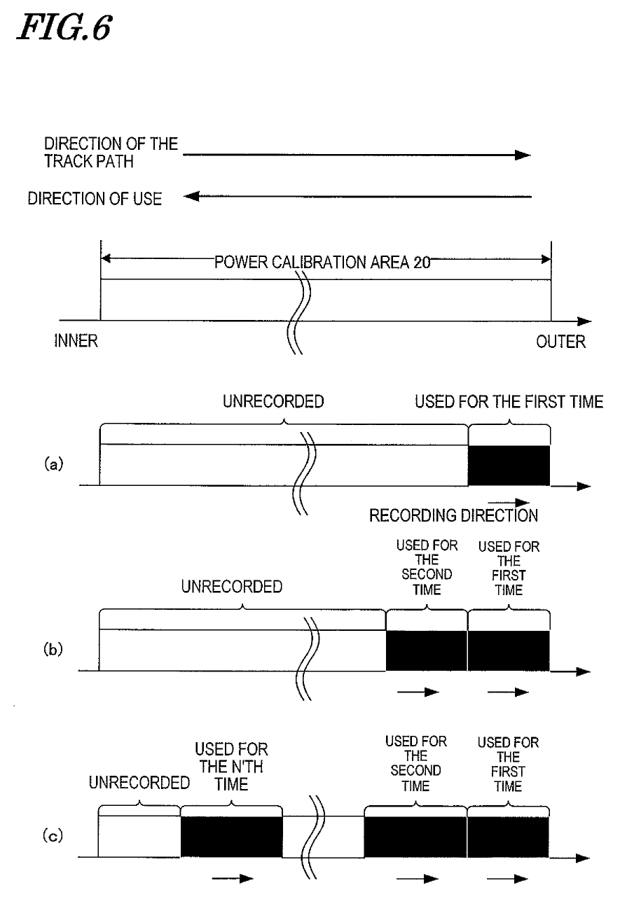

FIG. 6 shows an example of how to use the power calibration areas more specifically. A method of using the power calibration areas in the opposite direction to the track path will be described. In FIG. 6, the power calibration area 20 of L0 layer will be described as an example. Whereas the track path of L0 layer is used from the innermost end toward the outermost end, the power calibration area 20 is used from the outermost end toward the innermost end. Namely, the first time the power calibration area 20 is used, as shown in FIG. 6(a), a position which is inner from the outer border of the power calibration area 20 by the size to be used is set as the start position of the data. Then, the data is recorded in the direction of the track path. The next time the power calibration area 20 is used, as shown in FIG. 6(b), the start position of the recording in FIG. 6(a) is set as the end position. A position which is inner from the end position by the size to be used is set as the start position of the data. Then, the data is recorded in the direction of the track path. This is repeated thereafter.

This will be described in more detail. An access to the optical disc is made using a PBA, and accesses for continuous recording or the like are made in an ascending order of the PBA. For making an access to a target address for recording or the like, confirmation processing (synchronization) of the access position is performed as follows. The optical head (not shown) is moved (seek operation) to a position before the target address, and the optical head is moved along the track 11 relying on the reflected light from the track 11, utilizing the rotation of the optical disc 1 by focus servo, until reaching the target address. Thus, the optical head is made ready to emit laser light for recording and reproduction from the target address. Therefore, if the power calibration area is used in the ascending order of the PBA like the track path, the following occurs. When the track is destroyed as described above, the address cannot be obtained the next time the power calibration area is used because the area before the target address is destroyed. As a result, the optical head cannot seek to an area before the target address, and cannot access the target address.

The strategy calibration area is used after the power calibration, i.e., after power calibration is performed. Therefore, such a restriction that the strategy calibration area is used in the opposite direction to the track path is not necessary, unlike the power calibration area. Hence, it is conceivable as one example, as shown in FIG. 5, that the strategy calibration areas of all the recording layers are used in the same direction (for example, from the outermost end toward the innermost end, regardless of the direction of the track path of the recording layers). If a power calibration area is used up but the strategy calibration areas of all the recording layers still have some room left, this manner of usage makes it possible to assign a strategy calibration areas for power calibration. More specifically, the strategy calibration areas may be used as follows. The strategy calibration areas of all the recording layers are used from the outermost end toward the innermost end. When the strategy calibration areas of all the recording layers have some capacity left, a part at the innermost end of a strategy calibration area can be re-assigned as the power calibration area for power calibration (because the innermost end is unused in all the recording layers, the same condition as that of the power calibration areas can be guaranteed).

(3) How to Provide Information on the OPC Areas

In the case of a rewritable optical disc such as BD-RE, the OPC areas can be randomly used. By contrast, in the case of a write once optical disc such as BD-R, recording can be made only once in the OPC areas also. As described above, recording may not be performed at an optimal power in the OPC areas, especially in the power calibration areas. Therefore, how much of the areas has been used may not be determined based on the recording state of the medium. As the number of recording layers or areas increases, it is wasteful to check the using state of all the areas each time. Therefore, it is effective that a write once optical disc or the like has pointer information which indicates how much of the areas has been used as management information.

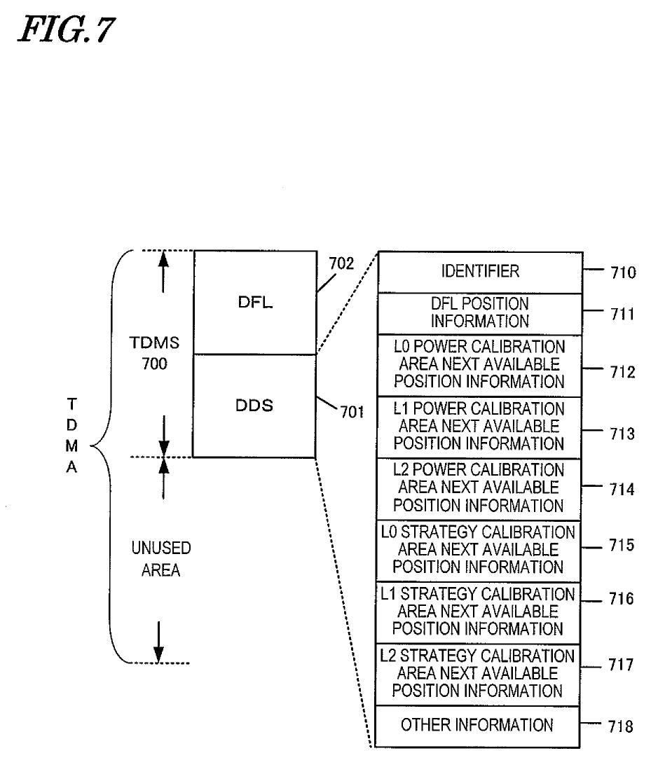

FIG. 7 shows an example of information regarding the power calibration areas and the strategy calibration areas in a write once optical disc. Here, the same area arrangement as shown in FIG. 3 will be described as an example.

In the lead-in zone 13, the lead-out zone 15 or the like of the optical disc 1, a management information area (not shown) called a DMA (Disc Management Area or Defect Management Area) usable for recording management information is provided. In the case of a write once optical disc, a DMA is an area in which final management information (DMS) is recorded at the time of finalization. Therefore, a temporary DMA area (not shown; hereinafter, referred to as “TDMA”) separate from the DMA area may be secured, so that transitional management information before finalization can be updated in a write once manner.

In the TDMA, a TDMS 700 is recorded including a DFL 702 which is information on defect positions and a DDS 701 including the position information on the DFL 702, the position information on the areas of the optical disc and the like. As the TDMS and the DMS, basically the same type of data is recorded. Between TDMS and the DMS, the locations of the DFL 702 and the DDS 701 are inverted. FIG. 7 is provided to show information on the recording calibration. Therefore, the TDMS 700, which is information recorded at recordable timings, i.e., at transitional timings before the finalization, will be described as an example.

The DDS 701 includes an identifier 710 indicating that this information is a DDS, DFL position information 711 indicating the position at which the DFL 702 is recorded, L0 power calibration area next available position information 712 indicating a position of the power calibration area 20 which can be used the next time, L1 power calibration area next available position information 713 indicating a position of the power calibration area 21 which can be used the next time, L2 power calibration area next available position information 714 indicating a position of the power calibration area 22 which can be used the next time, L0 strategy calibration area next available position information 715 indicating a position of the strategy calibration area 30 which can be used the next time, L1 strategy calibration area next available position information 716 indicating a position of the strategy calibration area 31 which can be used the next time, and L2 strategy calibration area next available position information 717 indicating a position of the strategy calibration area 32 which can be used the next time.

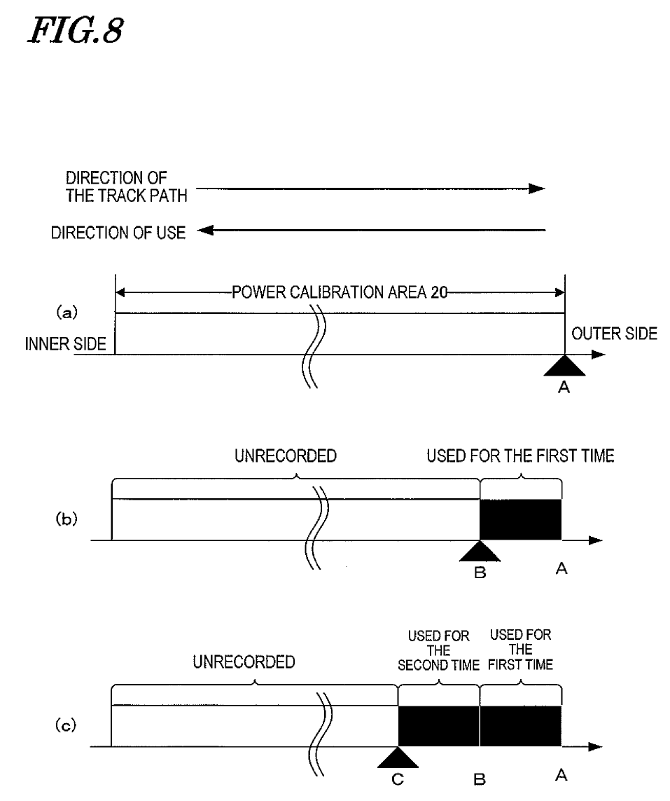

FIG. 8 shows next available position information. In FIG. 8, the power calibration area 20 of L0 layer will be described as an example.

It is assumed that the power calibration area 20 is to be used from the outermost end toward the innermost end as shown in FIG. 8. In the state where the power calibration area 20 is not used at all, as shown in FIG. 8(a), the L0 power calibration area next available position information indicates PBA:A, which is the outermost position of the power calibration area 20. After the power calibration area 20 is used once, as shown in FIG. 8(b), the L0 power calibration area next available position information indicates PBA:B. After the power calibration area 20 is used one more time, as shown in FIG. 8(c), the L0 power calibration area next available position information indicates PBA:C. The position indicated by the L0 power calibration area next available position information is changed in this manner.

Such position information is indicated by, for example, a PBA, which is position information in the optical disc 1.

As described above, the optical disc includes information on the position of each of the power calibration area and the strategy calibration area which can be used the next time for each recording layer. As the number of recording layers increases, the number of pieces of required information increases accordingly.

(4) Recording and Reproduction Apparatus

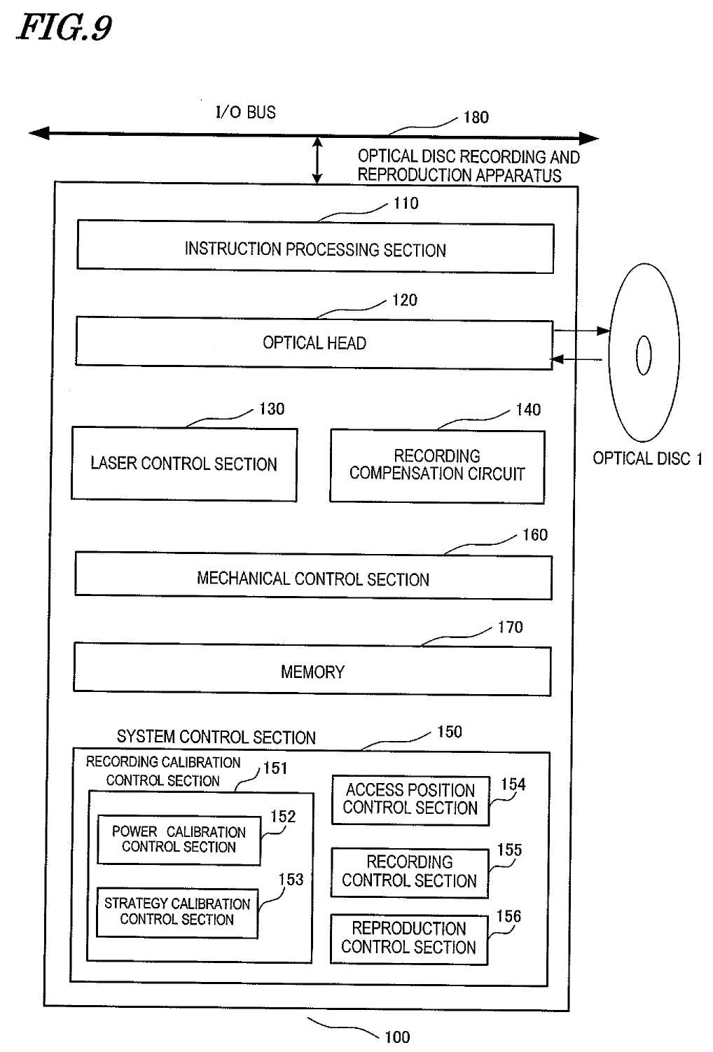

FIG. 9 shows a structure of an optical disc recording and reproduction apparatus 100 according to Embodiment 1 of the present invention, for performing recording to or reproduction from the optical disc 1.

The optical disc recording and reproduction apparatus is connected to an upper-level control apparatus (not shown) via an I/O bus 180. The upper-level control apparatus is, for example, a host computer (host PC).

The optical disc recording and reproduction apparatus includes an instruction processing section 110 for processing an instruction from the upper-level control apparatus, an optical head 120 for irradiating the optical disc 1 with laser light for performing recording or reproduction, a laser control section 130 for controlling the laser power which is output from the optical head 120, a recording compensation circuit 140 for converting a specified pulse width (strategy) into a recording pulse signal suitable to pit formation, a mechanical control section 160 for moving the optical head 120 to a target position or performing servo control, a system control section 150 for performing total control of the entire system processing including recording or reproduction processing to or from the optical disc 1, and a memory 170 for temporarily storing data.

Furthermore, the system control section 150 includes a recording calibration control section 151 for controlling recording calibration processing in the optical disc 1, an access position control section 154 for finding a position at which recording or reproduction is to be performed, from the management information or the like on the optical disc 1, and a recording control section 155 and a reproduction control section 156 for respectively performing recording and reproduction of data in accordance with an instruction from the host. Furthermore, the recording calibration control section 151 includes a power calibration control section 152 for controlling the power calibration and a strategy calibration control section 153 for controlling the strategy calibration.

When the optical disc 1 is inserted into the optical disc recording and reproduction apparatus 100, the action of the laser control section 130 and the mechanical control section 160 causes the optical head 120 to reproduce, at a prescribed radiation power, a control area (not shown) in the lead-in zone 13 of the recording layer L0 which indicates information on the optical disc 1 embedded therein in advance. Thus, the optical head 120 reads recording parameter information such as the radiation power or the like for performing recording in the recording layer L0, the recording layer L1 and the recording layer L2.

When a recording request is issued from the upper-level control apparatus, the recording calibration control section 151 of the system control section 150 of the optical disc recording and reproduction apparatus 100 performs recording calibration in an OPC area provided in each recording layer, and then performs recording on a target recording layer at the obtained recording power.

For performing recording calibration, the power calibration control section 152 of the recording calibration control section 151 performs power calibration for finding an optimal power using the power calibration area of each recording layer, and the strategy calibration control section 153 of the recording calibration control section 151 performs strategy calibration for finding an optimal strategy using the strategy calibration area in each recording layer. Thus, the optimal recording parameters are found. A position of each area used for recording calibration is found as follows. For example, in the case where the optical disc 1 is a write once optical disc, the reproduction control section 156 reads the management information or the like shown in section (4) of Example 1 of the present invention onto the memory 170, and the management information control section 154 determines a position usable for the recording calibration based on the read data. Alternatively, in the case where the optical disc 1 is a rewritable optical disc, the access position control section 154 finds an arbitrary position from the range of the power calibration area and the strategy calibration area provided in each recording layer.

(5) Recording Calibration Method

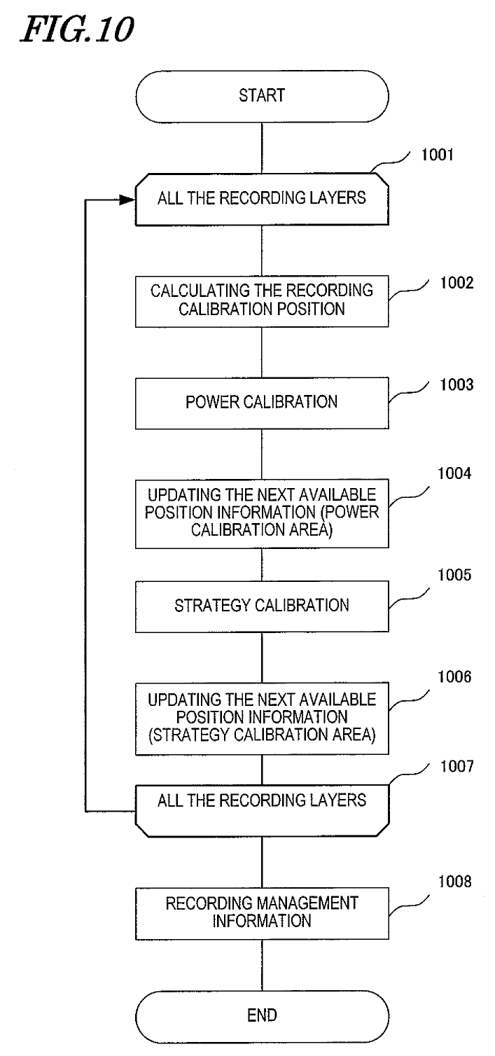

FIG. 10 shows a flow of a recording calibration procedure on the optical disc 1 of a write once type according to Embodiment 1 of the present invention. Here, the same area arrangement of the optical disc 1 as shown in FIG. 3 will be described as an example.

Step 1001: Processing in steps 1002 through 1007 described later is repeated for all the recording layers. For example, in the case of the optical disc 1 having the area arrangement shown in FIG. 3, the processing is repeated for the recording layer 3 (L0 layer), the recording layer 5 (L1 layer) and the recording layer 7 (L2 layer). In this example, the recording calibration is sequentially performed from the recording layer farthest from the disc surface toward the recording layer closest to the disc surface. This order is merely an example, and the present invention is not limited to this.

Step 1002: A position used for the recording calibration is calculated. Specifically, the reproduction control section 156 of the recording calibration control section 150 reads the latest DDS 701 included in the latest DMS 700 from the TDMA of the optical disc 1 onto the memory 170. Based on the read data, the access position control section 154 obtains the information on the position which can be used the next time, of each of the power calibration area and the strategy calibration area in a recording layer on which the recording calibration is to be performed (for example, for L0 layer, the L0 power calibration area next available position information 712 and L0 strategy calibration area next available position information 715). Based on this information, the access position control section 154 determines the size of the power calibration area and the strategy calibration area to be used for recording, and the direction of using the power calibration area and the strategy calibration area in the recording layer on which the recording calibration is to be performed. Then, the access position control section 154 calculates the start position of recording for power calibration to be performed next and the start position of recording for strategy calibration to be performed next. The “latest” DDS 701 means that the DDS 701 included in the latest of the DMS's 700 included in the TDMA, in which the transitional management information is updated.

Step 1003: Power calibration is performed. Specifically, the power calibration control section 152 of the recording calibration control section 151 determines the laser radiation power on the recording layer on which the recording calibration is to be performed (for example, a plurality of patterns of laser power), and sets the power in the laser control section 130. The power calibration control section 152 also sets a prescribed strategy (for example, the strategy described in the control area) in the recording compensation circuit 140. Furthermore, the power calibration control section 152 moves the optical head 120 to the start position of the recording for power calibration found in step 1002 using the mechanical control section 160, and performs the recording. Based on the recording quality of the recorded area (for example, the modulation degree or BER), the power calibration control section 152 finds an optimal power (for example, a power, among the plurality of patterns of laser power, at which the modulation degree is closest to the expected value).

If the recording for power calibration results in a failure, the access position control section 154 may find the access position again based on the position at which the failed recording was performed, and perform step 1003 again as a retry.

Step 1004: The power calibration area next available position information is updated. Specifically, the power calibration control section 152 updates the power calibration area next available position information, included in the data corresponding to the DDS 701 read onto the memory 170, of the recording layer on which the recording for power calibration was performed (for example, in the case of L0 layer, the L0 power calibration area next available position information 712). The update is made from the position at which the recording for power calibration was performed in step 1003.

Step 1005: Strategy calibration is performed. Specifically, the strategy calibration control section 153 of the recording calibration control section 151 sets the optimal recording power for the recording layer for the recording calibration, found in step 1003, in the laser control section 130, and also sets a strategy (for example, a plurality of patterns of strategy) in the recording compensation circuit 140. Furthermore, the strategy calibration control section 153 moves the optical head 120 to the start position of the recording for strategy calibration found in step 1002 using the mechanical control section 160, and performs the recording. Based on the recording quality of the recorded area (for example, the modulation degree or phase shift), the strategy calibration control section 153 finds an optimal recording strategy (for example, a strategy, among the plurality of patterns of strategy, at which the phase shift is smallest).

If the recording for strategy calibration results in a failure, the access position control section 154 may find the access position again based on the position at which the failed recording was performed, and perform step 1005 again as a retry.

Step 1006: The strategy calibration area next available position information is updated. Specifically, the strategy calibration control section 153 updates the strategy calibration area next available position information, included in the data corresponding to the DDS 701 read onto the memory 170, of the recording layer on which the recording for strategy calibration was performed (for example, in the case of L0 layer, the L0 strategy calibration area next available position information 715). The update is made from the position at which the recording for strategy calibration was performed in step 1005.

Step 1007: The processing from steps 1002 through 1006 described above is repeated for all the recording layers. When there is a recording layer on which recording calibration has not been finished, the processing returns to step 1001. When recording calibration has been finished on all the recording layers, the processing advance to step 1008.

Step 1008: The management information is updated. Specifically, the system control section 150 uses the recording control section 155 to record data, corresponding to a new DDS updated in steps 1004 and 1006 and is stored in the memory 170, in the TDMA as the new TDMS 700 in a write once manner.

The management information does not need to be updated after the recording calibration, and may be performed anytime before the optical disc 1 is discharged from the optical disc recording and reproduction apparatus 100.

The laser power and the strategy used in this case are based on those obtained by the recording calibration described above.

The recording calibration is performed in the procedure described above.

In FIG. 10, the recording calibration is performed at the same timing for all the recording layers. It is not necessary to perform the recording calibration at the same timing. The recording calibration on the target recording layer only needs to be done before usual recording is performed on the target recording layer at the latest. It is not necessary to actually perform the recording calibration on all the recording layers. For example, it is acceptable that the recording calibration is performed on at least one recording layer and the optimal parameters for the other recording layers are found by calculation based on the results obtained for the at least one recording layer. Even in this case, it is regarded that actual calibration is performed on the other recording layers.

Although not shown in FIG. 10, after the power calibration and the strategy calibration, margin checking processing or the like may be performed for checking whether or not the parameters obtained by the calibration are truly the optimal parameters.

It is not necessary to perform both the power calibration of step 1003 and the strategy calibration of step 1005. Specifically, for example, the following control is usable: in the case where the result of the calibration performed in the past using the optical disc recording and reproduction apparatus 100 (calibration history) is left in a drive inherent information area (also referred to as a “drive area”) or the like of the optical disc 1, strategy calibration is not performed (i.e., only the power calibration is performed).

In FIG. 10, the write once optical disc is described as an example. The recording calibration can be realized on a rewritable disc using substantially the same method. In this case, in step 1002, the recording calibration position is randomly selected from each of the power calibration area and the strategy calibration area, and the management information updating processing of steps 1004, 1006 and 1007 is not necessary, unlike in the case of the write once optical disc.

In Example 1 of the present invention, the OPC areas for recording calibration are provided in the lead-in zone 13. Where, for example, the OPC areas for recording calibration are also provided in the lead-out zone 15, recording calibration is performed in the OPC areas in, for example, the lead-out zone 15 in the above-described manner when necessary.

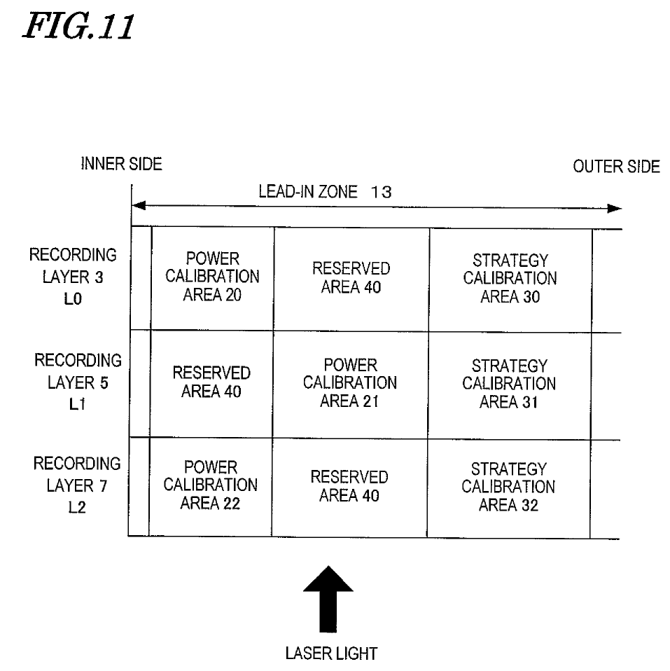

In Embodiment 1 of the present invention, the power calibration areas of all the recording layers are located at different radial positions. It is not necessary that the power calibration areas of all the recording layers are located at different radial positions. More specifically, the recording characteristic (transmittance or the like) of one recording layer significantly influences the recording state of an adjacent recording layer. Therefore, for example, as shown in FIG. 11, it is acceptable that the power calibration areas of at least the adjacent recording layers (for example, the power calibration area 21 of L1 layer and the power calibration area 20 of L0 layer, or the power calibration area 21 of L1 layer and the power calibration area 22 of L2 layer) are located at different positions, and that the power calibration areas of the non-adjacent recording layers (for example, the power calibration area 20 of L0 layer and the power calibration area 22 of L2 layer) are located at the same radial position. This arrangement does not significantly influence the power calibration results. Namely, even where the power calibration areas of the adjacent recording layers (in other words, the recording layers in which the directions of the track path are opposite to each other) are located at different radial positions and the strategy calibration areas of such recording layers are located at the same radial position, substantially the same effect as described in Embodiment 1 of the present invention can be provided. In addition, the following control is usable: in the case where the number of recording layers is further increased to six or eight, the number of recording layers in which the power calibration areas can be located at the same radial position is limited to N (N is a positive integer of 0 or greater).

### Embodiment 2

(1) Area Arrangement

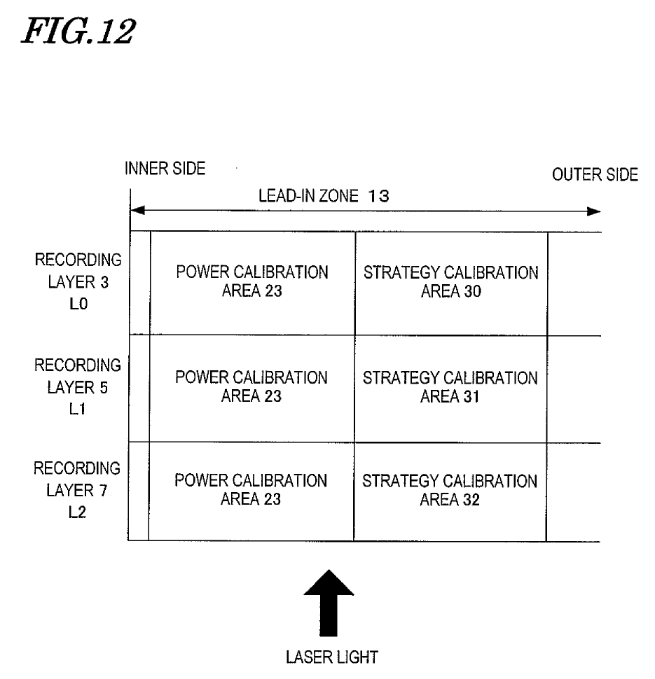

FIG. 12 shows an area arrangement of a write once optical disc including three recording layers according to Example 2 of the present invention.

As shown in FIG. 12, Embodiment 2 of the present invention is the same as Embodiment 1 of the present invention (FIG. 3) except that the power calibration areas 23 located at a prescribed radial position which is common to all the recording layers in appearance, like the strategy calibration areas 30, 31 and 32, and accordingly no area corresponding to the reserved area is secured. In Embodiment 1 of the present invention, the power calibration areas are located at different radial positions among different recording layers. As described above in Embodiment 1 of the present invention, it is desired that an area of each recording layer used for power calibration is controlled not to be influenced by the recording state of the other recording layers (namely, it is desired that recording for power calibration is not performed at the overlapping radial position among different recording layers). Therefore, Embodiment 2 has a feature in how to use the power calibration areas. This will be described in section (2).

In Embodiment 2 of the present invention, how to use the power calibration areas 23 will be described, but the same manner of usage is also applicable to the strategy calibration areas or the like.

In Embodiment 2 of the present invention, a write once optical disc is described as an example. As described in section (2) of Embodiment 1 of the present invention, the same manner of management is also applicable to a rewritable information recording medium and the same effect as for the write once optical disc is provided. In the case of the rewritable optical disc, the calibration areas are randomly used, and so it is difficult to keep the corresponding areas of the other recording layers unused (unrecorded). Therefore, it is effective to put the power calibration areas and the reserved areas of the recording layers into a uniform recording state (for example, to record 0 data in all these areas).

As described in Embodiment 2 of the present invention, recording power calibration is performed with a recording power which cannot be guaranteed as the optimal power, i.e., while changing the recording power. Therefore, a power calibration area of one recording layer used for recording power calibration is significantly influenced by the transmittance balance provided by the recording state of another recording layer. Such power calibration areas are used such that recording is not performed at an overlapping position among different recording layers. By contrast, strategy calibration is performed while fixing the recording power to the optimal recording power. Therefore, a strategy calibration area of one recording layer used for strategy calibration is unlikely to be influenced by the transmittance provided by the recording state of another recording layer. Such a strategy calibration area is located at the same radial position among all the recording layers. Owing to such an arrangement, the power calibration results of all the recording layers are protected against being influenced by the recording state of a different recording layer. In addition, the size of areas secured as OPC areas, which are required when the number of recording layers is increased (i.e., the total size of the power calibration areas, the strategy calibration areas and the reserved areas) can be suppressed to be minimum. Therefore, an area necessary for recording calibration can be secured, and the problem that the number of times of usage by the user (=the number of times the recording calibration can be made) is decreased is solved. In addition, the increase of the size of the lead-in zone 13 or the lead-out zone 15 can be suppressed, and the problem that the size of the data zone 14 is decreased and the size of the area usable by the user is decreased can be solved.

(2) How to Use the Areas

Regarding how to use the areas for recording calibration, Embodiment 2 of the present invention is the same as Embodiment 1 of the present invention except for the manner of using the power calibration areas 23.

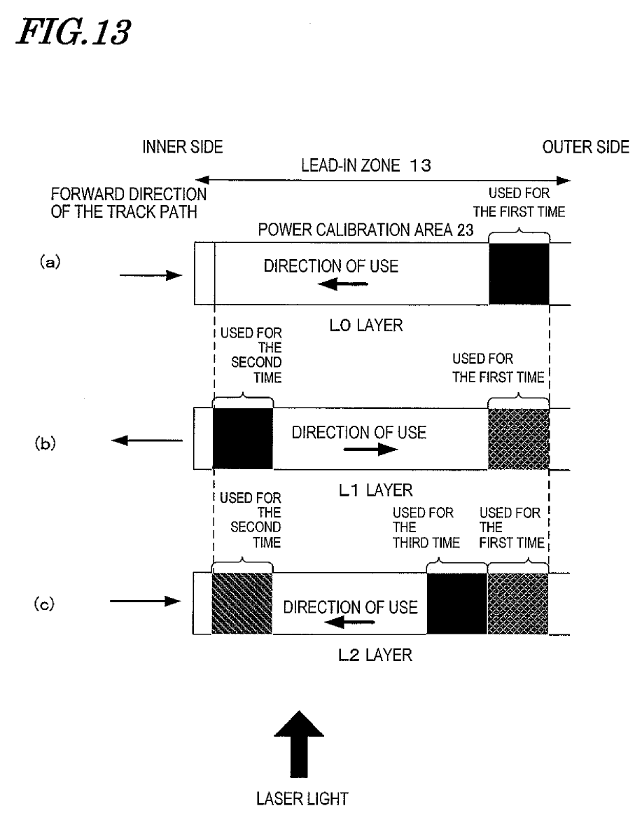

FIG. 13 shows an example of how to use the power calibration areas according to Embodiment 2 of the present invention. In this example, the power calibration area 23 of each recording layer is used in the opposite direction to the track path, as described with reference to FIG. 5 in section (2) of Embodiment 1 of the present invention. Namely, in each of L0 layer and L2 layer, the power calibration area 23 is used from the outermost end toward the innermost end; whereas in L1 layer, the power calibration area 23 is used from the innermost end toward the outermost end. It is assumed that the recording calibration is sequentially performed first on L0 layer, then on L1 layer and finally on L2 layer.

For performing power calibration on L0 layer in which the track path is used from the innermost end toward the outermost end, recording is performed on the power calibration area 23 in an unused state as follows. As shown in (a), a position which is inner from the outer border of the power calibration area 23 by the size to be used is set as the start position of the data. Then, the data is recorded in the direction of the track path. For performing power calibration on L1 layer in which the track path is used from the outermost end toward the innermost end, as shown in (b), a position which is outer from the inner border of the power calibration area 23 by the size to be used is set as the start position of the data. Then, the data is recorded in the direction of the track path. Finally, for performing power calibration on L2 layer in which the track path is used from the innermost end toward the outermost end like L0 layer, as shown in (c), the start position used in L0 layer shown in (a) is set as the end position. A position which is inner from the end position by the size to be used is set as the start position of the data. Then, the data is recorded in the direction of the track path. This is repeated for each recording layer thereafter.

In this manner, an area at a radial position different from the areas in the other recording layers is used. Namely, the recording for power calibration is performed in an area which does not overlap the areas already used in the other recording layers. Thus, power calibration can be performed with the same recording state among the recording layers. When a portion to be used in the area used from the innermost end overlaps a portion to be used in the area used from the outermost end, the power calibration areas 23 are used up.

In the example of FIG. 13, the recording power calibration is performed at the same timing for all the recording layers successively. Even in the case where calibration is performed in the power calibration area 23 of only a specific recording layer, the manner of usage and the effect are the same as described above.

As described in section (1) of Embodiment 1 of the present invention, for example, the end position of the area used in (c) is not at exactly the same radial position as the start position used in (a). It is necessary to consider the aligning errors or the influences of the characteristic of the laser light. Therefore, the start position in (c) needs to be inner from the same radial position as the start position used in (a) by the size corresponding to such influences (hereinafter, referred to as an “offset”) in proper working order.

(3) How to Provide Information on the OPC Areas

In Embodiment 2 of the present invention, as described in section (3) of Embodiment 1 of the present invention, it is effective that a write once optical disc or the like has pointer information which indicates how much of the areas has been used as management information.

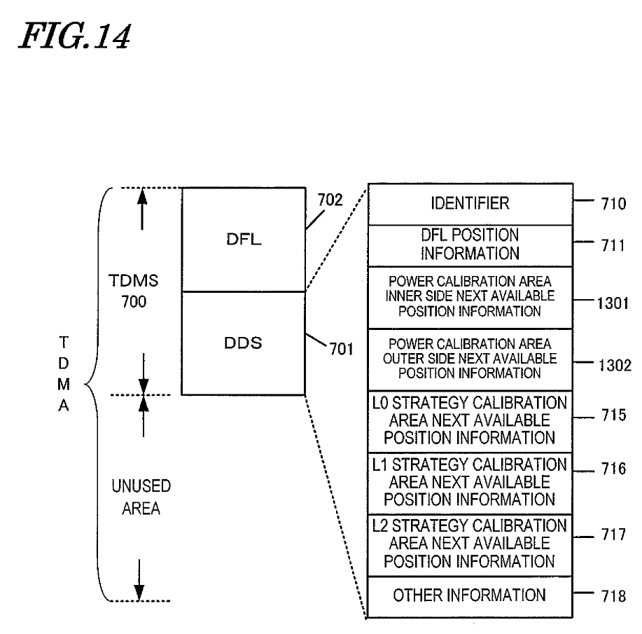

FIG. 14 shows an example of information regarding the power calibration areas and the strategy calibration areas in a write once optical disc. In FIG. 14, the same area arrangement as shown in FIG. 12 will be described as an example.

Regarding the strategy calibration areas, next available position information is provided for each recording layer as described in section (3) of Embodiment 1 of the present invention.

Regarding the power calibration areas, power calibration area inner side next available position information 1301 and power calibration area outer side next available position information 1302 are provided as information common to all the recording layers. In the example of FIG. 13, the power calibration area outer side next available position information 1302 is used and updated by the power calibration performed on each of L0 layer and L2 layer, in which the power calibration area is used from the outermost end toward the innermost end. The power calibration area inner side next available position information 1301 is used and updated by the power calibration performed on L1 layer, in which the power calibration area is used from the innermost end toward the outermost end. Since these pieces of information are common to all the recording layers, it is not sufficient to specify the position merely with the PBA information, unlike in section (3) of Embodiment 1 of the present invention. For example, the position needs to be specified by information regarding the radial position. Alternatively, the position needs to be specified by the PBA in the recording layer used immediately previously. In the latter case, when using the position actually, the PBA is converted into a PBA in the recording layer to be used.

As described in section (2) of Embodiment 2 of the present invention, the position usable the next time needs to be specified in consideration of the aligning errors of the disc or the influences of the characteristic of the laser light. Therefore, both the inner side next available position information and the outer side next available position information need to specify a position obtained by adding the above-mentioned offset to the actual end position. Alternatively, the areas need to be used from a position obtained by adding the offset, when actually using the position.

(4) Recording and Reproduction Apparatus

The recording and reproduction apparatus in Embodiment 2 of the present invention is the same as that described in section (4) of Embodiment 1 of the present invention with reference to FIG. 9 and will not be described here.

(5) Recording Calibration Method

The procedure of the recording calibration in Embodiment 2 of the present invention is the same as that described in section (5) of Embodiment 1 of the present invention with reference to FIG. 10 except for steps 1002 and 1004. Here, only the steps different from those in Embodiment 1 of the present invention will be described.

Step 1002: A position used for the recording calibration is calculated. Specifically, the reproduction control section 156 of the recording calibration control section 150 reads the latest DDS 701 included in the latest TDMS from the TDMA of the optical disc 1 onto the memory 170. Based on the read data, the access position control section 154 obtains the information on the position of each of the power calibration area and the strategy calibration area which can be used the next time, of a recording layer on which the recording calibration is to be performed (for example, for L0 layer, the power calibration area outer side next available position information 1302 and L0 strategy calibration area next available position information 715). Based on such information, the access position control section 154 determines the size of area to be used for recording in the power calibration area and the strategy calibration area, and the direction of using the power calibration area and the strategy calibration area of the recording layer on which the recording calibration is to be performed. Then, the access position control section 154 calculates the start position of recording for power calibration to be performed next and the start position of recording for strategy calibration to be performed next. The “latest” DDS 701 means that the DDS 701 included in the latest of the DMS's 700 included in the TDMA, in which the transitional management information is updated.

Step 1004: The power calibration area next available position information is updated. Specifically, the power calibration control section 152 updates the power calibration area next available position information, included in the data corresponding to the DDS 701 read onto the memory 170, of the recording layer on which the recording for power calibration was performed (for example, in the case of L0 layer, the power calibration area outer side next available position information 1302). The update is made from the position at which the recording for power calibration was performed in step 1003.

In Embodiment 2 of the present invention, as described in section (1) of Embodiment 1 of the present invention, an unused area of the power calibration area 23 corresponding to the radial position already used in the other recording layers, namely, an area from the inner border of the power calibration area 23 to the power calibration area inner side next available position information 1301, and an area from the power calibration area outer side next available position information 1302 to the outer border, of a recording layer in which such a radial position has not been used, are usable as a strategy calibration area, as a management information area, or for data recording or other processing which is not influenced, unlike power calibration, by the recording state of the other recording layers. It is difficult to determine whether or not such a radial position of that recording layer has been actually used. Therefore, for example, for L1 layer in which the power calibration area 23 is used from the innermost end, it is more effective to set an area from the power calibration area outer side next available position information 1302 to the outer border of the power calibration area 23 as a usable area.

In Embodiment 2 of the present invention, the power calibration areas 23 of all the recording layers need to have the same size excluding the influences such as the aligning errors. By contrast, the strategy calibration areas do not need to have the same size among all the recording layers. For example, in the case where the strategy calibration areas in all the recording layers are used in the same direction, for example, from the outermost end toward the innermost end, the strategy calibration areas of all the recording layers should have the outer border at the same radial position but do not need to have the inner border at the same radial position.

In Embodiment 2 of the present invention, an area in each recording layer used for power calibration does not overlap the areas used in the other recording layers. It is not necessary that the areas used for power calibration are located at different radial positions among all the recording layers. More specifically, as described in Embodiment 1 of the present invention with reference to FIG. 11, the recording characteristic (transmittance or the like) of one recording layer significantly influences the recording state of an adjacent recording layer. Therefore, for example, it is acceptable that among at least adjacent recording layers, areas at different radial positions are used for power calibration, but among non-adjacent recording layers, overlapping areas (areas including the same radial position) are used for power calibration. This arrangement does not significantly influence the power calibration results. Namely, even where the areas used for power calibration of the adjacent recording layers (in other words, the recording layers in which the directions of the track path are opposite to each other) do not overlap, but the strategy calibration areas of such recording layers are located at the same radial position, substantially the same effect as described in Embodiment 2 of the present invention can he provided. In addition, the following control is usable: in the case where the number of recording layers is further increased to six or eight, the number of recording layers in which the power calibration areas can be located at the same radial position is limited to N (N is a positive integer of 0 or greater).

### Embodiment 3

(1) Area Arrangement

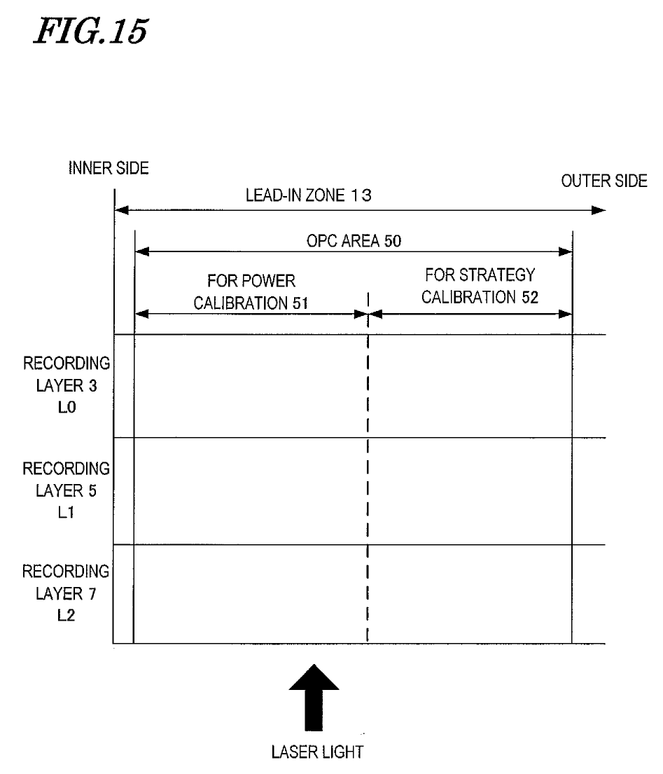

FIG. 15 shows an area arrangement of a write once optical disc including three recording layers according to Example 3 of the present invention.

The lead-in zone 13 of the optical disc 1 includes OPC areas 50 for recording calibration.

The OPC areas 50 are located at the same radial position among all the recording layers, and are used for power calibration or strategy calibration. Unlike in Embodiment 1 and 2 of the present invention, the OPC areas 50 are not clearly divided into power calibration areas or strategy calibration areas. Instead, an arbitrary size of each OPC area 50 is assigned as a part of area for power calibration 51 or a part of area for strategy calibration 52 before the OPC area 50 is used for recording for the first time. This will be described later in section (2) in detail.

(2) How to Use the Areas

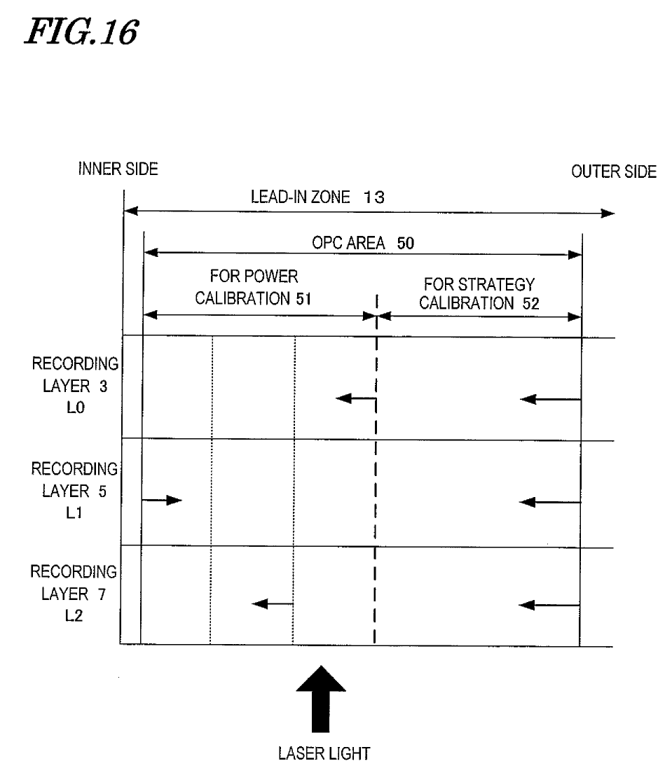

FIG. 16 shows an example of how to use the OPC areas 50 according to Embodiment 3 of the present invention. In FIG. 16, the same area arrangement as shown in FIG. 15 will be described as an example.

Before each OPC area 50 is used for recording for the first time, the OPC area 50 is assigned as the part of area for power calibration 51 and the part of area for strategy calibration 52, each of an arbitrary size (i.e., the areas 51 and 52 are assigned at an arbitrary assignment ratio) Also among the recording layers, the part of areas for power calibration 51 are assigned in an arbitrary size (at an arbitrary assignment ratio) so as not to overlap (so as not to be located at the same radial position). The part of areas for strategy calibration 52 may overlap among the recording layers, and therefore remain at the overlapping position (the same radial position) among the recording layer.

The part of areas for power calibration 51 are used in the opposite direction to the track path like in Embodiments 1 and 2 of the present invention. Specifically, in each of L0 layer and L2 layer, in which the track path is used from the innermost end toward the outermost end, the area assigned as the part of area for power calibration 51 is used from the outermost end toward the innermost end, with the outer border thereof being the start position of the data. In L1 layer, in which the track path is used from the outermost end toward the innermost end, the area assigned as the part of area for power calibration 51 is used from the innermost end toward the outermost end, with the inner border thereof being the start position of the data.

By contrast, as the part of areas for strategy calibration 52, overlapping areas are used among the recording layers. Specifically, the part of areas for strategy calibration 52 are used in one direction (for example, from the outermost end toward the innermost end) regardless of the direction of the track path.

The part of area for power calibration 51 and the part of area for strategy calibration 52 may be assigned so as to have an equal size. Alternatively, where the optical disc 1 has a narrow (small) power margin because of the feature of the manufacturer, the part of area for power calibration 51 may be assigned to have a larger size than the part of area for strategy calibration 52. Still alternatively, where the optimal power can be calculated by estimation to some degree but the optimal strategy cannot be easily found without actually performing recording calibration, the part of area for strategy calibration 52 may be assigned to have a larger size than the part of area for power calibration 51.

In Example 3 of the present invention, the OPC areas 50 are provided in the lead-in zone 13. For example, the OPC areas 50 may further be provided in the lead-out zone 15. In this case, the assignment ratio of the part of area for power calibration 51 and the part of area for strategy calibration 52 may be varied between the OPC areas 50 provided in the lead-in zone 13 and the OPC areas 50 provided in the lead-out zone 15.

In Embodiment 3 of the present invention, each OPC area 50 is divided into the part of area for power calibration 51 and the part of area for strategy calibration 52. A part of the OPC area 50 may be assigned as an area for a different purpose (for example, an area for checking the margin).

(3) How to Provide Information on the OPC Areas

In Embodiment 3 of the present invention, as described in section (3) of Embodiments 1 and 2 of the present invention, it is effective that a write once optical disc or the like has pointer information which indicates how much of the areas has been used as management information.

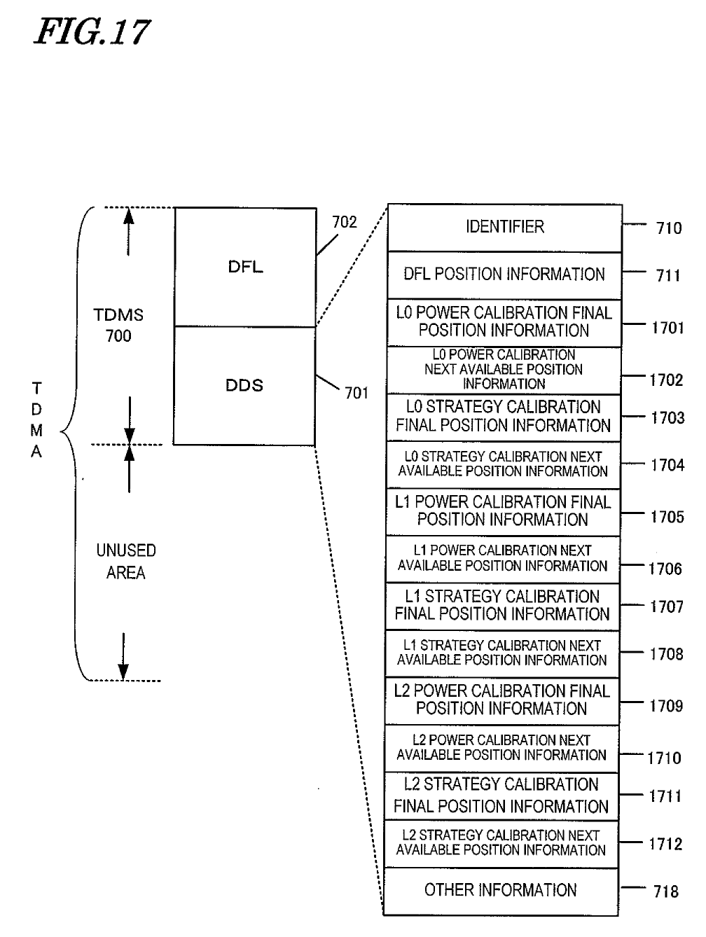

FIG. 17 shows an example of information regarding the power calibration areas and the strategy calibration areas in a write once optical disc. In FIG. 17, the same area arrangement as shown in FIG. 15 will be described as an example.

In addition to an identifier 710 and DFL position information 711, the DDS 701 includes end position information and next usable position information on the part of areas for power calibration 51 and end position information and next usable position information on the part of areas for strategy calibration 52 as information relating to the recording calibration in each recording layer. Such information relating to the recording calibration is provided by the number of the recording layers. Namely, the DDS 701 includes L0 power calibration end position information 1701, L0 power calibration next available position information 1702, L0 strategy calibration end position information 1703 and L0 strategy calibration next available position information 1704 as information on the L0 layer; L1 power calibration end position information 1705, L1 power calibration next available position information 1706, L1 strategy calibration end position information 1707 and L1 strategy calibration next available position information 1708 as information on the L1 layer; and L2 power calibration end position information 1709, L2 power calibration next available position information 1710, L2 strategy calibration end position information 1711 and L2 strategy calibration next available position information 1712 as information on the L2 layer.

As described above, the assignment of the part of area for power calibration 51 and the part of area for strategy calibration 52 in each recording layer, and the assignment of the part of areas for power calibration 51 among the recording layers, are determined with an arbitrary size before the OPC areas 50 are used for the first time (for example, at the time of the initialize format). Therefore, the power calibration end position information and the strategy calibration end position information of each recording layer are established at this timing. At the time of assignment, the power calibration next available position information and the strategy calibration next available position information each indicate the start position of the assigned area. When the end position information and the next available position information indicate the same position, or when the interval between the end position information and the next available position information (=remaining size) is less than the size used by one cycle of calibration, it is determined that the area for calibration in that recording layer is used up.

The end position information and the next available position information are each represented by, for example, a PBA, but may be represented by information such as the radial position.

In the above, the DDS 701 includes the end position information. Substantially the same effect is provided where the DDS 701 includes remaining size information, which indicates a usable size of the assigned area, instead of the end position information.

In the case where the DDS 701 includes the end position information, such information is not changed after the part of area for power calibration 51 and the part of area for strategy calibration 52 are assigned. Alternatively, such information may be changed when the areas are re-assigned as described in Embodiments 1 and 2 of the present invention. In the case where the DDS 701 includes the remaining size information, the remaining size information is updated each time the OPC area 50 is used, like the next available position information.

As described in Embodiments 1 and 2 of the present invention, in the case where next usable position information is provided, it is necessary to consider the aligning errors or the influences of the characteristic of the laser light. Therefore, for example, especially the next available position information on a power calibration area or the like, which is influenced by the recording state of another recording layer, needs to indicate position information obtained by adding the above-mentioned offset size to the position at which recording was actually finished, or the power calibration area needs to be actually used from a position obtained by adding the offset size to the position at which recording was finished.

(4) Recording and Reproduction Apparatus

The recording and reproduction apparatus in Embodiment 3 of the present invention is the same as that described in section (4) of Embodiment 1 of the present invention with reference to FIG. 9 and will not be described here.

(5) Recording Calibration Method

The procedure of the recording calibration in Embodiment 3 of the present invention is the same as that described in section (5) of Embodiment 1 of the present invention with reference to FIG. 10 except for steps 1002, 1004 and 1006. Here, only the steps different from those in Embodiment 1 of the present invention will be described.

Step 1002: A position used for the recording calibration is calculated. Specifically, the reproduction control section 156 of the recording calibration control section 150 reads the latest DDS 701 included in the latest TDMS from the TDMA of the optical disc 1 onto the memory 170. Based on the read data, the access position control section 154 obtains the information on the position in each of the power calibration area and the strategy calibration area which can be used the next time, of a recording layer on which the recording calibration is to be performed (for example, for L0 layer, the L0 power calibration next available position information 1702 and L0 strategy calibration next available position information 1704). Based on this information, the access position control section 154 determines the size of area to be used for recording in the power calibration area and the strategy calibration area, and the direction of using the power calibration area and the strategy calibration area of the recording layer on which the recording calibration is to be performed. Then, the access position control section 154 calculates the start position of recording for power calibration to be performed next and the start position of recording for strategy calibration to be performed next. The “latest” DDS 701 means that the DDS 701 included in the latest of the DMS's 700 included in the TDMA, in which the transitional management information is updated.

Step 1004: The power calibration area next available position information is updated. Specifically, the power calibration control section 152 updates the power calibration area next available position information, included in the data corresponding to the DDS 701 read onto the memory 170, of the recording layer on which the recording for power calibration was performed (for example, in the case of L0 layer, the power calibration area next available position information 1702). The update is made from the position at which the recording for power calibration was performed in step 1003.

Step 1006: The strategy calibration next available position information is updated. Specifically, the strategy calibration control section 153 updates the strategy calibration next available position information, included in the data corresponding to the DDS 701 read onto the memory 170, of the recording layer on which the recording for strategy calibration was performed (for example, in the case of L0 layer, the L0 strategy calibration next available position information 1704). The update is made from the position at which the recording for strategy calibration was performed in step 1005.

In Example 3 of the present invention, an area in each recording layer used for power calibration does not overlap the areas used in the other recording layers. It is not necessary that the areas used for power calibration are located at different radial positions among all the recording layers. More specifically, as described in Embodiment 1 of the present invention with reference to FIG. 11, the recording characteristic (transmittance or the like) of one recording layer significantly influences the recording state of an adjacent recording layer. Therefore, for example, it is acceptable that among at least adjacent recording layers, areas at different radial positions are used for power calibration, but among non-adjacent recording layers, overlapping areas (areas including the same radial position) are assigned for power calibration. This arrangement does not significantly influence the power calibration results. Namely, even where the areas used for power calibration of the adjacent recording layers (in other words, the recording layers in which the directions of the track path are opposite to each other) do not overlap, but the strategy calibration areas of such recording layers are located at the same radial position, substantially the same effect as described in Embodiment 3 of the present invention can be provided. In addition, the following control is usable: in the case where the number of recording layers is further increased to six or eight, the number of recording layers in which the power calibration areas can be located at the same radial position is limited to N (N is a positive integer of 0 or greater).

In Examples 1, 2 and 3 of the present invention, the power calibration area (or the area 51 for power calibration) is described as an area used for power calibration and the strategy calibration area (or the area 52 for strategy calibration) is described as an area used for strategy calibration. Furthermore, the areas used for power calibration are described as areas which do not overlap among adjacent recording layers at the same radial position, and the areas for strategy calibration are described as areas which include overlapping parts at the same radial position among the adjacent recording layers. More strictly, “areas used for power calibration which do not overlap among adjacent recording layers at the same radial position” are areas in which recording can be performed at a free recording power (for example, power calibration) including a recording power which cannot be guaranteed as a recording power suitable for the optical disc 1. The “areas used for strategy calibration which include overlapping parts at the same radial position among the adjacent recording layers” are areas in which recording is performed at a recording power which can be guaranteed as a recording power suitable for the optical disc 1, namely, a recording power which, when used for recording in an area, provides the area with a transmittance within a prescribed range without destroying the transmittance balance. These areas may be separately located in each recording layer. Namely, in the case where it is guaranteed that step-by-step recording can be performed while changing the recording power within the range which can be guaranteed as the recording power suitable for the optical disc 1 (within the range in which the post-recording transmittance is within a prescribed range), power calibration may be performed in strategy calibration areas (or the areas 52 for strategy calibration) including areas overlapping at the same radial position among adjacent recording layers. The strategy calibration areas including the overlapping parts may be used for checking whether the recording calibration result truly indicates the optimal condition (margin checking), as well as for strategy calibration. Using such a method, the number of times non-overlapping areas are used can be reduced. As a result, the size of the non-overlapping area provided in each recording layer can be reduced. Accordingly, the size of the area including the overlapping part can be increased. Thus, the number of times the areas are used for recording calibration can be advantageously increased.

Some specific examples of such a method will be described in detail.

For example, it is assumed that the optical disc 1 as a recording target is registered in the optical disc recording and reproduction apparatus 100 as a tuned optical disc 1. In this case, the strategy calibration areas including overlapping parts at the same radial position among adjacent recording layers can be used for power calibration and strategy calibration, assuming that the recording can be guaranteed. Alternatively, in the case where the result of calibration performed in the past on a target recording layer by the optical disc recording and reproduction apparatus 100 (calibration history) is left in a drive inherent information area (also referred to as a “drive area”) or the like of the optical disc 1, i.e., in the case where calibration is performed using the history information, the strategy calibration areas may be used for power calibration and strategy calibration as the recording calibration on the recording layer, assuming that the recording power for the recording layer can be guaranteed. Alternatively, in the case where the results of recording layer on all the recording layers are left as a calibration history, the following method is effective. From the calibration history, the power ratio, the strategy change amount or the like between a reference recording layer and another recording layer is found. Actual recording calibration (power calibration or strategy calibration) is performed on the reference recording layer, whereas actual recording layer is not performed on the another recording layer. The calibration value of the another recording layer is found using the power ratio or the strategy change amount which was found based on the calibration result on the reference recording layer on which actual calibration was performed and also based on the calibration history. Using such a method, the consumed amount of the power calibration area or the strategy calibration area used for recording calibration is suppressed. In this case, what is used is history calibration. Therefore, the strategy calibration areas including the overlapping parts at the same radial position among adjacent recording layers are used for actual recording calibration. In addition, the following method is usable. As the reference recording layer, the recording layer, for example, farthest from the disc surface (for example, L0 layer in the case of the optical disc 1 shown in FIG. 3) is first used. When the strategy calibration area in that recording layer is used up, the recording layer next farthest from the disc surface (for example, L1 layer in the case of the optical disc 1 shown in FIG. 3) is used as the reference layer. Using this method, the following effect is provided for the strategy calibration area on which recording is performed at a power suitable for the optical disc 1. When recording is performed on a certain recording layer, even the strategy calibration area in a recording layer closer to the laser light radiation side can be kept unused (in the case of a write once optical disc, unrecorded). Therefore, it is absolutely unnecessary to consider the influence of the transmittance.

In Embodiments 1, 2 and 3 of the present invention, the recording calibration area (OPC area) for recording calibration is divided into an area for power calibration and an area for strategy calibration, which are separately secured as different areas in each recording layer. This concept is not limited to recording calibration areas. In more detail, the fundamental concept of the present invention is to provide a rough calibration areas used for rough calibration by which conditions are narrowed down to conditions suitable to recording to some extent by changing the recording power, like power calibration in recording calibration, and a precise calibration area used for precise calibration (fine-tuning) by which conditions are to narrowed down to an optimal condition, like strategy calibration area in recording calibration. These areas are provided as separate areas in each recording layer. In addition, in Embodiments 1, 2 and 3 of the present invention, because calibration of the recording power is the target, the rough calibration areas used for power calibration are located at different radial positions in consideration of the recording state (transmittance balance) of the other recording layers. Namely, the fundamental concept of providing a rough calibration area and a precise calibration area as separate areas in each recording layer is applicable to various calibrations other than recording calibration.

In Embodiments 1, 2 and 3 of the present invention, the optical disc 1 includes three recording layers, for example. The number of the recording layers does not need to be three. Substantially the same effect can be provided where the optical disc 1 includes six or eight recording layers, needless to say.

In Embodiments 1, 2 and 3, a write once information recording medium is used as an example. Substantially the same effect can be provided for a rewritable information recording medium.

In Embodiments 1 and 2 of the present invention, the power calibration areas have the same size among the recording layers, and the strategy calibration areas have the same size among the recording layers. In Embodiment 3 of the present invention, the OPC areas 50 have the same size among the recording layers. Alternatively, these areas may have different sizes among the recording layers. Specifically, for example, the size of the power calibration area or the strategy calibration area may be varied in accordance with the size of the management information area (not shown) included in the lead-in zone 13 or the lead-out zone 15 of each recording layer. Alternatively, the size of the power calibration area or the strategy calibration area may be varied in accordance with the size of a spare area (not shown) provided in the data zone 14 as an exchangeable area or the like for the defect block of the like.

In Embodiments 1, 2 and 3 of the present invention, the recording calibration is performed at the same timing for all the recording layers. It is not necessary to perform the recording calibration at the same timing. The recording calibration on the target recording layer only needs to be done before usual recording is performed on the target recording layer at the latest. It is not necessary to actually perform the recording calibration on all the recording layers. For example, it is acceptable that the recording calibration is performed on at least one recording layer and the optimal parameters for the other recording layers are found by calculation based on the results obtained for the at least one recording layer. Even in this case, it is regarded that actual calibration is performed on the other recording layers. As one recording layer, for example, a recording layer having the largest remaining size in the area for recording calibration (power calibration area, strategy calibration area, OPC area) may be selected, or a recording layer having the largest size of the area for recording calibration may be selected.

In section (3) of Embodiments 1, 2 and 3 of the present invention, as information for identifying the usable position (i.e., for distinguishing a used position or an unused position), information regarding the next usable position is provided. Other than this method, for example, a method of managing the used area and the unused area by a bitmap provides substantially the same effect.

As described in Embodiments 1, 2 and 3 of the present invention, in order to realize a method of re-assigning a part of the strategy calibration area as a power calibration area when the power calibration area is used up, information on the final usable position (end position) of each area, the remaining size, using direction or the like may be further provided. Considering that after the power calibration area is used, a reserved area located at the same radial position in another recording layer is also used, it is effective to consider that one recording layer includes a plurality of power calibration areas and strategy calibration areas, and to keep a list of the start position and the size of such a plurality of power calibration areas and such a plurality of strategy calibration areas, in addition to the next usable position information.

In Embodiments 1, 2 and 3 of the present invention, the power calibration areas are used in the opposite direction to the track path, and the strategy calibration areas are used in the same direction among all the recording layers. This is merely an example.

For example, in the case where a part of one of the power calibration area or the strategy calibration area is re-assigned as a part of the other area, the power calibration area and the strategy calibration area may be used in the same direction (for example, in L0 layer, from the outermost end toward the innermost end).

Alternatively, it is possible to simply use the power calibration area in the opposite direction from the track path but to use the strategy calibration area in the same direction as the track path. This method works even when an area in the power calibration area is destroyed. Even if recording fails due to a medium defect or the like during the strategy calibration, re-try processing can be performed in continuation from the previous recording. In this manner, access performance can be improved.

In the above, a possible destruction of the power calibration area is mentioned. Some of the medium can never be put into a state where a PBA embedded as wobbles or the like cannot be obtained even when recording is performed at a high power to some extent. Therefore, the direction of use may not be limited for the power calibration areas either, and both the power calibration area and the strategy calibration area may be simply used in the same direction as the track path. Thus, the access performance can be improved both during power calibration and strategy calibration.

For a rewritable information recording medium, overwriting and random access are possible. Therefore, it is not necessary to restrict the manner of usage, unlike the write once information recording medium. Substantially the same manner of usage as described above is also applicable to the rewritable information recording medium. In that case, substantially the same effect can be provided as for the write once information recording medium.

In Embodiments 1, 2 and 3 of the present invention, the areas for power calibration and the areas for strategy calibration do not overlap. For example, power calibration may be performed with light passing through the area which was used for strategy calibration. Specifically, in the case where power calibration is to be performed on L0 layer and the area of the L1 layer at the same radial position has already been used by strategy calibration performed at a certain recording layer, the area of the L0 layer may be used for power calibration because the influence of the transmittance is low.

In Embodiments 1, 2 and 3 of the present invention, a tracking method called “opposite path” is used for the optical disc 1. Substantially the same effect can be provided even by, for example, “parallel path” by which the physical addresses are assigned from the innermost end toward the outermost end in an ascending order (or in a descending order) in all the recording layers.

An information recording medium according to the present invention is applicable to a write once optical disc and a rewritable optical disc including a plurality of recording layers.

An information recording and reproduction method according to the present invention is applicable to an optical disc drive apparatus capable of performing recording to or reproducing from a write once optical disc and a rewritable optical disc including a plurality of recording layers.

What is claimed is:

1. An information recording medium comprising a plurality of recording layers; wherein:
each recording layer includes a recording calibration area usable for performing calibration accompanying recording; and
the recording calibration area includes:
a precise calibration area usable for performing precise calibration, which is final recording calibration for finding an optimal condition for recording; and
a rough calibration area usable for performing rough calibration, which is rough recording calibration carried out before the precise calibration.

2. An information recording medium comprising a plurality of recording layers; wherein:
each recording layer includes a recording calibration area usable for performing recording calibration;
the recording calibration areas of two adjacent recording layers among the plurality of recording layers are located so as to have areas overlapping in a radial direction;
the recording calibration includes:
first calibration, accompanied by recording at an arbitrary recording power, performed for finding a recording power generally suitable to the information recording medium; and
second calibration accompanied by recording at the recording power found by the first calibration; and
regarding the recording calibration areas,
the recording calibration areas, of the two adjacent recording layers, used for the first calibration do not include areas overlapping in the radial direction; and
the recording calibration areas, of the two adjacent recording layers, used for the second calibration include areas overlapping in the radial direction.

3. The information recording medium of claim 2, wherein the recording power generally suitable is a recording power which provides a post-recording transmittance in a prescribed range.

4. An information recording medium comprising a plurality of recording layers; wherein:
each recording layer includes:
a first calibration area usable for performing recording at an arbitrary recording power; and
a second calibration area usable for performing recording at a recording power generally suitable to the information recording medium;
the first calibration areas of two adjacent recording layers among the plurality of recording layers are located so as not to include areas overlapping in a radial direction; and
the second calibration areas of two adjacent recording layers among the plurality of recording layers are located so as to include areas overlapping in the radial direction.

5. The information recording medium of claim 4, wherein the recording power generally suitable is a recording power which provides a post-recording transmittance in a prescribed range.

6. An information recording apparatus for an information recording medium including a plurality of recording layers; wherein:
each recording layer includes a recording calibration area usable for performing calibration accompanying recording;
the recording calibration area includes:
a precise calibration area usable for performing precise calibration, which is final recording calibration for finding an optimal condition for recording; and
a rough calibration area usable for performing rough calibration, which is rough recording calibration carried out before the precise calibration; and
the information recording apparatus comprises:
(a) a rough calibration control section for performing the rough calibration in the rough calibration area; and
(b) a precise calibration control section for performing the precise calibration in the precise calibration area.

7. An information recording apparatus for an information recording medium including a plurality of recording layers; wherein:
each recording layer includes a recording calibration area usable for performing recording calibration;
the recording calibration areas of two adjacent recording layers among the plurality of recording layers are located so as to have areas overlapping in a radial direction;
the recording calibration includes:
first calibration, accompanied by recording at an arbitrary recording power, performed for finding a recording power generally suitable to the information recording medium; and
second calibration accompanied by recording at the recording power found by the first calibration; and
the information recording apparatus comprises:
(a) a first calibration section for performing the first calibration in one of two adjacent recording layers among the plurality of recording layers, such that the recording calibration area for the first calibration does not overlap, in the radial direction, the recording calibration area of the other of the two recording layers already used for the first calibration; and
(b) a second calibration section for performing the second calibration.

8. The information recording apparatus of claim 7, wherein the recording power generally suitable is a recording power which provides a post-recording transmittance in a prescribed range.

9. An information recording apparatus for an information recording medium including a plurality of recording layers; wherein:
each recording layer includes:
a first calibration area usable for performing recording at an arbitrary recording power; and
a second calibration area usable for performing recording at a recording power generally suitable to the information recording medium;
the first calibration areas of two adjacent recording layers among the plurality of recording layers are located so as not to include areas overlapping in a radial direction;
the second calibration areas of two adjacent recording layers among the plurality of recording layers are located so as to include areas overlapping in the radial direction; and
the information recording apparatus comprises:
(a) a first calibration control section for performing recording calibration in the first calibration area; and
(b) a second calibration control section for performing recording calibration in the second calibration area.

10. The information recording apparatus of claim 9, wherein the recording power generally suitable is a recording power which provides a post-recording transmittance in a prescribed range.

11. An information recording method for an information recording medium including a plurality of recording layers; wherein:
each recording layer includes a recording calibration area usable for performing calibration accompanying recording;
the recording calibration area includes:
a precise calibration area usable for performing precise calibration, which is final recording calibration for finding an optimal condition for recording; and
a rough calibration area usable for performing rough calibration, which is rough recording calibration carried out before the precise calibration; and
the information recording method comprises the steps of:
(a) performing the rough calibration in the rough calibration area; and
(b) performing the precise calibration in the precise calibration area.

12. An information recording method for an information recording medium including a plurality of recording layers; wherein:
each recording layer includes a recording calibration area usable for performing recording calibration;
the recording calibration areas of two adjacent recording layers among the plurality of recording layers are located so as to have areas overlapping in a radial direction;
the recording calibration includes:
first calibration, accompanied by recording at an arbitrary recording power, performed for finding a recording power generally suitable to the information recording medium; and
second calibration accompanied by recording at the recording power found by the first calibration; and
the information recording method comprises the steps of:
(a) performing the first calibration in one of two adjacent recording layers among the plurality of recording layers, such that the recording calibration area for the first calibration does not overlap, in the radial direction, the recording calibration area of the other of the two recording layers already used for the first calibration; and
(b) performing the second calibration in the recording calibration area.

13. The information recording method of claim 12, wherein the recording power generally suitable is a recording power which provides a post-recording transmittance in a prescribed range.

14. An information recording method for an information recording medium including a plurality of recording layers; wherein:
each recording layer includes:
a first calibration area usable for performing recording at an arbitrary recording power; and
a second calibration area usable for performing recording at a recording power generally suitable to the information recording medium;
the first calibration areas of two adjacent recording layers among the plurality of recording layers are located so as not to include areas overlapping in a radial direction;
the second calibration areas of two adjacent recording layers among the plurality of recording layers are located so as to include areas overlapping in the radial direction; and
the information recording method comprises the steps of:
(a) performing recording calibration in the first calibration area; and
(b) performing recording calibration in the second calibration area.

15. The information recording method of claim 14, wherein the recording power generally suitable is a recording power which provides a post-recording transmittance in a prescribed range.
